(19) United States
(12) Patent Application Publication
(10) Pub. No.: US 2025/0021248 A1
(43) Pub. Date: Jan. 16, 2025

(54) MANAGING AND RANKING MEMORY RESOURCES

(71) Applicant: Microsoft Technology Licensing, LLC, Redmond, WA (US)

(72) Inventors: Lisa Ru-Feng HSU, Durham, NC (US); Aninda MANOCHA, Durham, NC (US); Ishwar AGARWAL, Redmond, WA (US); Daniel Sebastian BERGER, Seattle, WA (US); Stanko NOVAKOVIC, Seattle, WA (US); Janaina Barreiro GAMBARO BUENO, Redmond, WA (US); Vishal SONI, Redmond, WA (US)

(21) Appl. No.: 18/897,840

(22) Filed: Sep. 26, 2024

Related U.S. Application Data
(62) Division of application No. 17/102,084, filed on Nov. 23, 2020.

(51) Int. Cl. G06F 3/06

(52) U.S. Cl. CPC G06F 3/0631; G06F 3/0604; G06F 3/0647; G06F 3/0679

(57) ABSTRACT

The present disclosure relates to systems, methods, and computer-readable media for managing tracked memory usage data and performing various actions based on memory usage data tracked by a memory controller on a memory device. For example, systems described herein involve collecting and compiling data across one or more memory controllers to evaluate characteristics of the memory usage data to determine hotness metric(s) for segments of a memory resource. The systems described herein may perform a variety of segment actions based on the hotness metric(s). In addition, the systems described herein can compile the memory usage data according to one or more access granularities. This compiled data may further be shared with multiple accessing agents in accordance with access resolutions of the respective accessing agents.

### CROSS REFERENCE TO RELATED APPLICATIONS

This application is a Divisional of U.S. application Ser. No. 17/102,084, filed on Nov. 23, 2020, the entirety of which is incorporated herein by reference.

### BACKGROUND

Recent years have seen a rise in the use of computing devices (e.g., mobile devices, personal computers, server devices, cloud computing systems) to receive, store, edit, transmit, or otherwise utilize digital data for various processing applications and services. Indeed, it is now common for individuals and businesses to employ the use of computing resources on cloud computing systems. As demand for computing resources continues to grow, there is an interest in innovations that expand available memory capacity. In addition, as demand grows for memory resources, demand for additional information on how memory is being used has also grown.

One limitation in connection with memory systems is a lack of effective memory tracking. For example, conventional systems for tracking memory usage are often expensive to obtain and involve a significant amount of processing overhead. For instance, in order to build a comprehensive history of memory access and modification patterns, a computing device would need to scan usage data with high frequency while expending considerable resources. As a result, many conventional memory systems do not track memory usage.

Another limitation in connection with tracking data generally is that many types of tracking data are cleared after an accessing entity reads the tracking data. As a result, where multiple entities may attempt to access or benefit from monitored or tracked data, the information obtained after a read may not be accurate. As a result, memory systems are generally limited to a single tenant or device having access to the memory resource, as allowing multiple entities to access memory usage data would limit the effectiveness of the tracked memory usage information.

These and other problems exist in connection with managing and accessing memory systems.

### BRIEF DESCRIPTION OF THE DRAWINGS

FIG. 1 illustrates an example environment including computing nodes having access to memory usage data on a memory controller system in accordance with one or more embodiments.

FIG. 2 illustrates an example implementation in which a computing node obtains access to memory usage data on a memory controller system in accordance with one or more embodiments.

FIG. 3 illustrates an example implementation of a memory controller system in accordance with one or more embodiments.

FIG. 4 illustrates another example environment including multiple computing nodes having access to heatmaps across pooled memory devices in accordance with one or more embodiments.

FIG. 5 illustrates another example environment showing a more detailed implementation of the memory ranking system on the computing device in accordance with one or more embodiments.

FIG. 6 illustrates an example workflow in which a memory ranking system collects memory usage data and determines hotness metrics for memory segments of a memory resource in accordance with one or more embodiments.

FIG. 7 illustrates an example workflow in which a memory ranking system collects and compiles memory usage data at different access resolutions and provides the memory usage data to accessing agents in accordance with one or more embodiments.

FIGS. 8A-8B illustrate example implementations in which a memory ranking system combines sampled memory usage data within memory records based on different access resolutions in accordance with one or more embodiments.

FIG. 9 illustrates an example series of acts for determining memory hotness metrics for a memory resource and selectively performing actions on different memory segments based on the memory hotness metrics.

FIG. 10 illustrates an example series of acts for collecting memory usage data based on different access resolutions and sharing the memory usage data with different accessing agents based on the different access resolutions.

FIG. 11 illustrates certain components that may be included within a computer system.

### DETAILED DESCRIPTION

The present disclosure is generally related to tracking memory usage data on a memory controller system and providing a mechanism that enables one or multiple accessing agents (e.g., computing nodes, applications, virtual machines) to access the memory usage data. In particular, and as will be discussed in further detail below, one or more memory controller systems on one or more memory devices may generate and manage heatmaps including memory usage data for one or more accessing agents. The memory controller system(s) may facilitate access to the heatmap(s) enabling one or more accessing agents to obtain frequent and low-overhead access to memory usage data without interfering with other accessing agents that may similarly have access to memory resources.

In addition to tracking memory usage data, the present disclosure relates to evaluating the memory usage data to determine various metrics and selectively performing actions on memory segments of a memory resource based on the evaluation and determined metrics. For example, and as will be discussed in further detail below, a memory ranking system on a computing node can read heatmaps from the memory controller system to determine hotness metrics (e.g., segment hotness score, segment hotness ranking) based on one or a combination of multiple access metrics (e.g., frequency metric, recency metric, density metric) tracked for a memory resource. Based on the hotness metrics, the memory ranking system can perform a variety of actions on select memory segments. For example, the memory ranking system may facilitate migrating one or more segments to another memory device (e.g., a local memory), performing memory management for containers, monitoring mitigations for security reasons, estimating working-set sizes, etc.

As an illustrative example, the memory ranking system may obtain memory usage data including a variety of access metrics for a memory resource from a memory controller. The memory ranking system may generate a memory usage record that includes compiled data from multiple heatmaps and which provide access trends over time. The memory ranking system may then evaluate the access metrics to determine one or more hotness metrics including indicators such as frequency, recency, and density of access by one or more accessing agents. The memory ranking system may then facilitate a number of actions on select memory segments of the memory resource in accordance with the determined hotness metrics.

In addition to tracking and evaluating the memory usage data, the present disclosure also relates to enabling sharing of the memory usage data to one or more accessing agents based on unique characteristics of the accessing agents. For example, and as will be discussed in further detail below, a memory ranking system can determine different access resolutions (e.g., heatmap accessing frequencies) for multiple accessing agents and generate memory records that simulate memory usage data as if the data were collected by the respective accessing agents. Indeed, features and functionality of the memory ranking system described herein may sample memory usage data at a particular frequency based on different access resolutions for a variety of accessing agents and compile the memory usage data in a way that prevents the different accessing agents from interfering with one another as a result of reading heatmaps at conflicting frequencies.

As an illustrative example, the memory ranking system may identify access resolutions indicating timing information associated with frequencies with which a plurality of access agents is configured to sample memory usage data for a memory resource. The memory ranking system may then sample the memory usage data at a particular granularity (e.g., a sample granularity) based on a common factor of the access resolutions and compile the samples of memory within a memory record. The memory ranking system may then cause data from the memory record to be shared with the respective accessing agents based on the determined access resolutions of the accessing agents.

The present disclosure includes a number of practical applications that provide benefits and/or solve problems associated with tracking and accessing memory usage data. Examples of these applications and benefits are discussed in further detail below.

For example, while one or more embodiments described herein relate to a memory controller that manages access to a memory resource for a single accessing agent, one or more embodiments described herein involve generating heatmaps for each of a plurality of accessing agents. By generating and maintaining heatmaps for each of multiple accessing agents, the memory controller system can enable any number of devices, virtual machines, or other accessing agents to read memory usage data for respective accessing agents. This can be particularly useful in connection with a pooled memory system that is accessible by multiple devices and/or multiple accessing agents.

The memory controller system may also generate and manage heatmaps that include a wide variety of access metric s. By way of example and not limitation, the memory controller system can generate and maintain segment entries for corresponding segments of memory that include access metrics such as access frequency, access recency, access density, access decay, and other useful metrics. Each of these access metrics may be used by a variety of applications and services in a number of ways, which will be discussed in connection with examples herein.

In addition to tracking a variety of useful metrics, the memory controller system can incorporate features and functionality that provide quick and convenient access to the memory usage data without reducing latency in accessing memory resources. For example, and as will be discussed in further detail below, the memory controller system can utilize different access protocols that utilize different access paths (e.g., control paths, data paths, processing paths) in accessing the heatmaps and the memory resources. As another example, and as will be discussed below, the memory controller system can generate and maintain the memory usage data within data objects having a particular size and format that facilitates fast access to the memory usage data while minimizing expense of processing resources.

Furthermore, the memory controller system provides features and functionality that enables tracking of memory usage data across a variety of memory devices having different tracking capabilities. In particular, features and functionality described in connection with one or more embodiments may similarly apply to a variety of memory device-types. This applicability to different memory device-types provides enhanced tracking flexibility when implemented within newer memory systems and/or within existing memory systems. Indeed, features described in connection with systems described herein may be used in combination with existing memory systems and/or hardware having disparate capabilities to accomplish many of the benefits and advantages described herein.

Systems described herein additionally provide features that enable a computing device to evaluate segments on one or multiple memory resources to determine which of a collection of memory segments are ‘hotter’ than other memory segments. For example, the memory ranking system may evaluate the variety of access metrics tracked by a memory controller to determine one or multiple hotness metrics for memory segments. Indeed, where the memory controller(s) can collect a variety of access metrics, a memory ranking system can consider a variety of relevant metrics to determine one or more actions that may be performed on a memory segment based on a hotness score, hotness ranking, or other hotness metric associated with a corresponding memory segment.

In addition, where one or more applications or other accessing agents have different access resolutions associated with frequencies at which the agents would obtain memory usage information, one or more embodiments described herein provide features and functionality to enable accessing agents having different access resolutions to read or otherwise obtain memory usage information without interfering with one another. Indeed, even where information from a heatmap is cleared when read, and where accessing agents are configured to read data at different frequencies, the memory ranking system may sample memory usage data at a determined sample granularity that enables multiple accessing agents to effectively make use of the tracked memory usage information. As will be discussed in further detail below, the memory ranking system enables this sharing of memory usage data to be performed without causing some portion of the memory usage data to be lost to other accessing agents that may have lower, higher, or simply different access resolutions.

As illustrated in the foregoing discussion, the present disclosure utilizes a variety of terms to describe features and advantages of the systems herein. Additional detail is now provided regarding the meaning of some example terms.

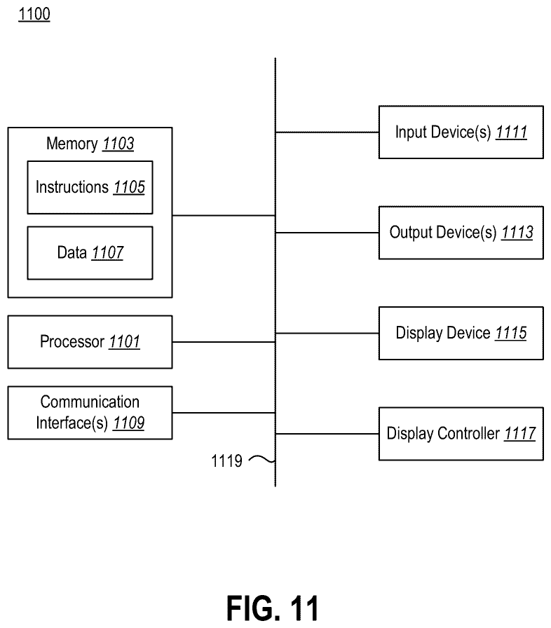

For example, as used herein, a “computing node,” “server node,” “host device,” or other electronic device may be used interchangeably to refer to any computing device having one or more processing units and capable of implementing an application and/or virtual machine thereon. In one or more embodiments described herein, a computing node may refer to any computing device capable of communicating with and utilizing memory resources (e.g., pooled memory) managed by a corresponding memory controller(s). A computing node may refer to one or more server devices on a network of connected computing devices (e.g., a cloud computing system). Alternatively, a computing node may refer to a mobile or non-mobile computing device, such as a laptop, desktop, phone, tablet, or other device capable of accessing memory resources of one or more memory devices. Additional detail in connection with some general features and functionalities of computing nodes and other computing devices will be discussed below in connection with FIG. 11.

As used herein, “memory resources” or a “memory system” may refer to accessible memory across one or more computing devices. For example, memory resources may refer to a local memory store (or simply “local memory”) having blocks of memory that are co-located on a memory device and/or managed by one or more integrated memory controllers on a computing node. Memory resources may also refer to any memory resource that is managed by a memory controller, including local, external, remote, or pooled memory that is accessible to one or multiple computing nodes. Indeed, memory resources may refer to any memory device managed by a memory controller positioned between an accessing agent and memory.

The memory resources may include a variety of memory types. For example, in one or more embodiments described herein, a memory resource may refer to dynamic random-access memory (DRAM), static random-access memory (SRAM), flash memory, or other non-persistent memory source. In one or more embodiments, the memory system includes dual in-line memory module (DIMM) devices that provide an accessible memory source. In one or more embodiments, the memory system may include multiple memory devices having similar or different types of memory. Further, in one or more embodiments, a local memory has a lower latency speed than a memory resource managed by the memory controller system.

As used herein, a “memory block” may refer to any unit of memory on a memory controller system. For example, a memory block may refer to some quantity of memory that is accessible to one or multiple accessing agents. In one or more embodiments described herein, a memory block includes a plurality of memory segments, which may refer to a portion of a memory block anywhere between a very small portion of memory (e.g., 4 kilobytes (KBs)) to a significantly larger portion of memory (e.g., one gigabyte (GB)). In one or more embodiments, a memory segment refers to any sized block of physical memory. A memory block may include any number of memory segments thereon.

As used herein, “memory usage data” may refer to any information associated with a history of use corresponding to segments of memory. For example, as will be discussed in further detail below, memory usage data may include a variety of access metrics indicating characteristics about a particular memory segment, such as how old a particular segment is, a frequency that the memory segment has been accessed, how recently the memory segment has been accessed, and/or how granular or dense the memory access has been in connection with the memory segment.

As used herein, a “heatmap” may refer to a set of memory usage data associated with one or multiple accessing agents. In one or more embodiments described herein, a heatmap may refer to a table or other data object including memory usage data for a corresponding device, application, virtual machine, or other accessing agent. As will be discussed in further detail below, a heatmap may include entries (e.g., segment entries) having memory usage data associated with respective memory segments of a memory resource. In one or more embodiments described herein, a heatmap refers to a table of values where each row of the table refers to a segment entry. In one or more embodiments, multiple heatmaps are maintained within a heatmap register on the memory controller system.

As used herein, an “accessing agent” may refer to any device and/or software instance having access to a memory resource and/or heatmap. For example, in one or more embodiments described herein, an accessing agent refers to a computing node having access to memory resources and a heatmap on a memory controller system. As another example, an accessing agent may refer to a virtual machine, application, or other software/hardware instance having access to memory resources and a heatmap on a memory controller system. In one or more embodiments, a single computing node may have multiple accessing agents implemented thereon. Further, while one or more examples described herein refer specifically to computing nodes acting as accessing agents, features and functionalities discussed in connection with computing nodes accessing and compiling memory usage data from heatmaps may similarly apply to other types of accessing agents, including multiple accessing agents on the same computing node.

As used herein, a “hotness metric” refers to any characterization of a memory segment based on tracked access instances for the memory segment. For example, in one or more embodiments described herein, a hotness metric refers to an indication of importance associated with how often, how recently, and/or how densely a memory segment has been accessed. For instance, a hotness metric may include a score or value indicative of a frequency metric, recency metric, and/or density metric (or combination thereof) that has been tracked or otherwise determined for a corresponding memory segment. In addition, or as an alternative, a hotness metric may include an indication of a nature or type of access with respect to a given memory segment. For example, a hotness metric may indicate whether a memory segment is accessed via write operations, read operations, or a combination of both. Indeed, a hotness metric may include some characterization for a memory segment based on a combination of any of the above factors. In one or more implementations, a hotness metric refers to a score, categorization, label, or other characterization based on a combination of factors associated with access instances for the corresponding memory segment(s).

As used herein, an “access resolution” or “access granularity” may refer to a frequency or sampling rate with which an accessing agent is configured to access memory usage data. For instance, an access resolution for an application or virtual machine may refer to a frequency with which the application or virtual machine is programmed or otherwise configured to access a heatmap on a memory controller. As will be discussed below, multiple accessing agents (e.g., virtual machines, applications) on the same or across different devices may be configured to access the same heatmap at different access resolutions (e.g., at different frequencies).

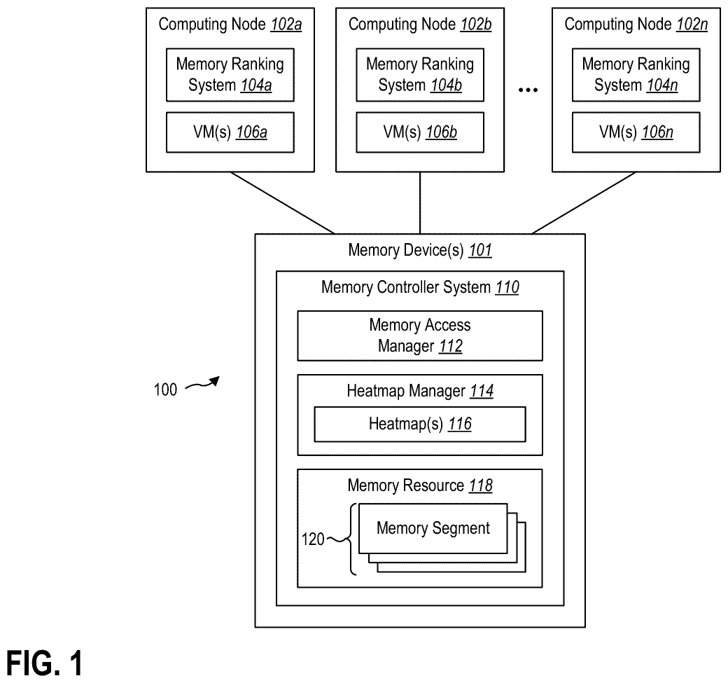

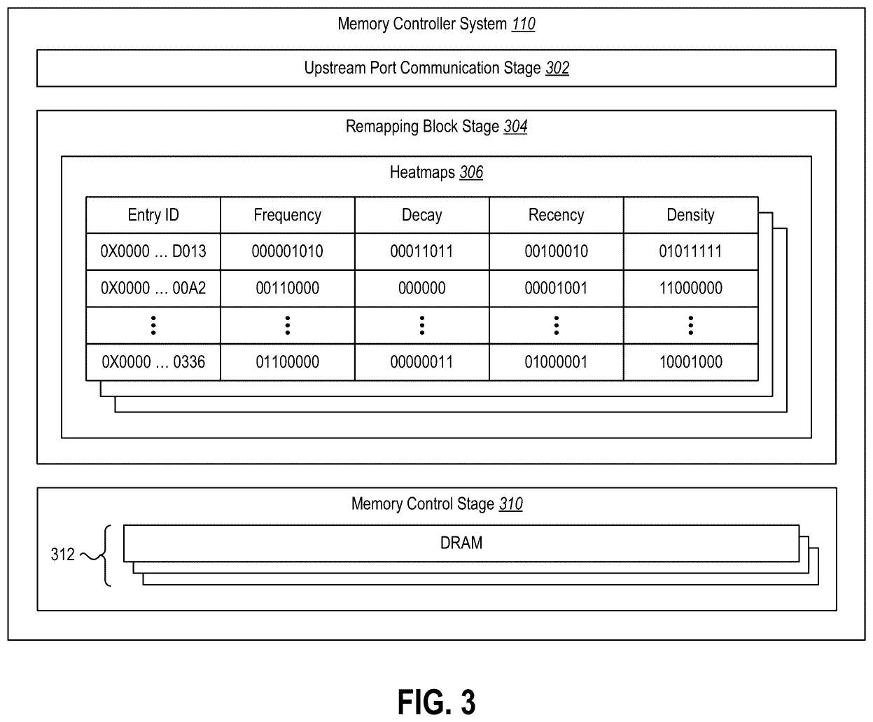

Additional detail will now be provided regarding examples of various systems in relation to illustrative figures portraying example implementations. In particular, FIGS. 1-2 and FIG. 4 illustrate example environments in which a memory controller system may be implemented in accordance with one or more implementations while FIG. 3 illustrates a more detailed implementation of a memory controller system that may be implemented in connection with any of the memory devices shown in the various computing environment.

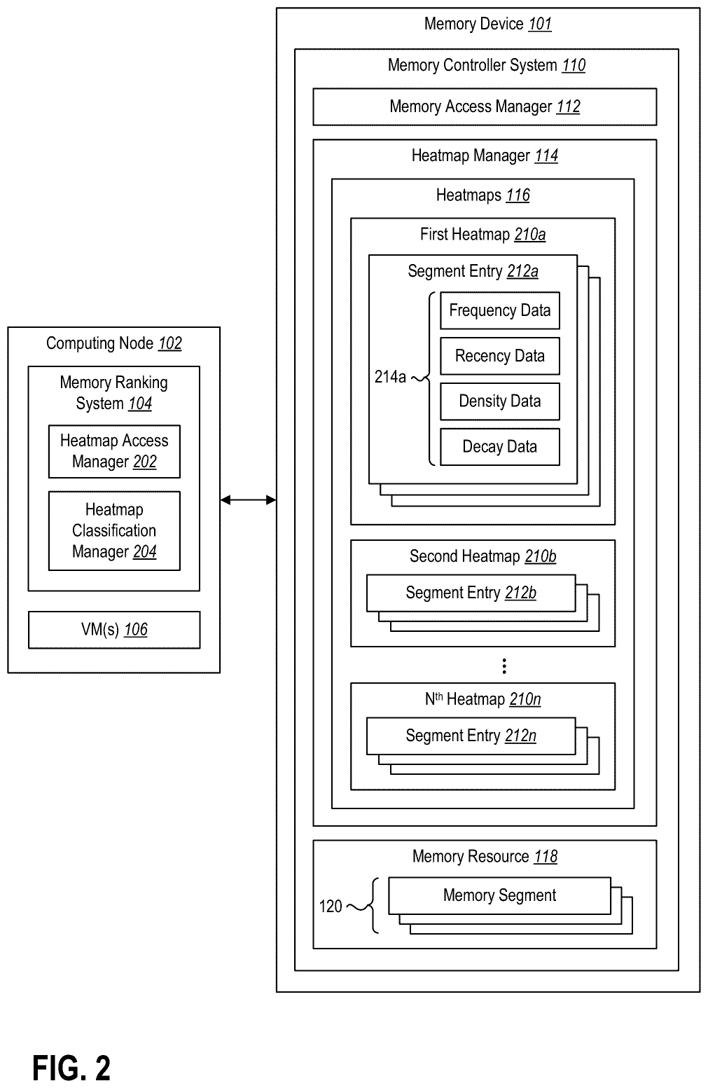

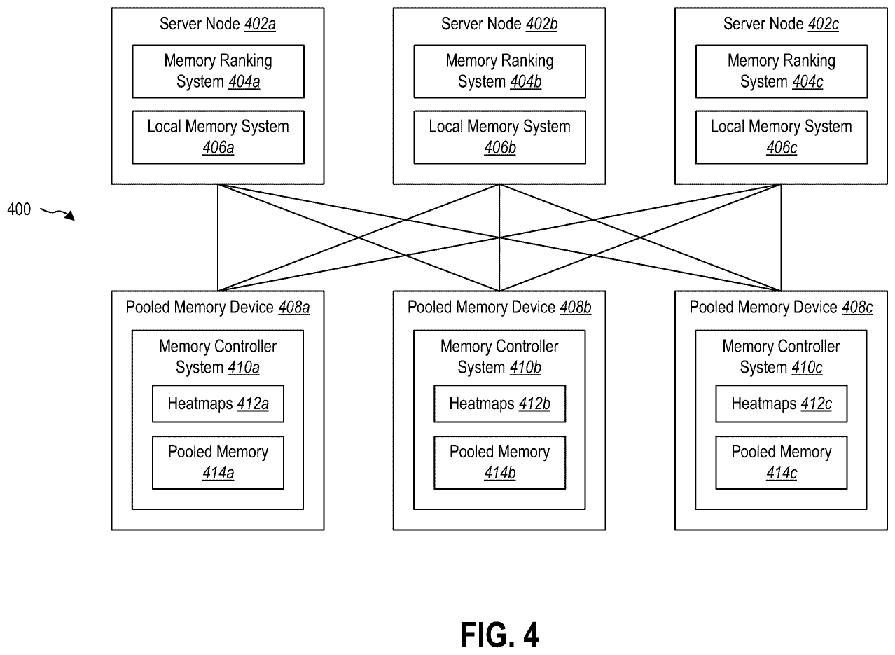

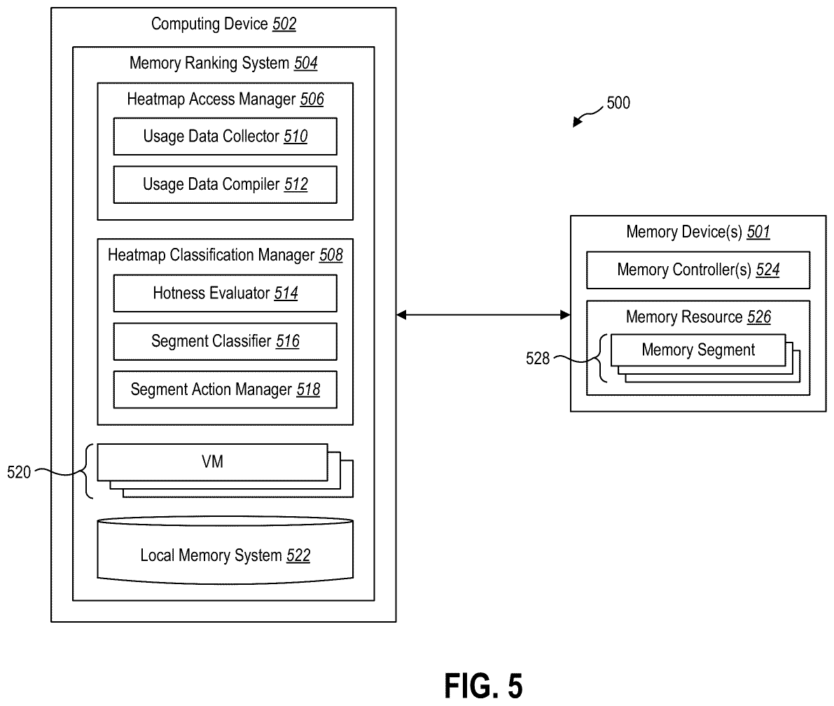

For ease in explanation, FIG. 1 illustrates an example implementation in which multiple computing nodes have access to a memory resource managed by a memory controller system that tracks memory usage for a memory resource on a memory device(s). FIG. 2 illustrates a more detailed implementation showing a single computing node having access to a memory resource managed by a memory controller system that similarly tracks memory usage for a memory resource on a memory device. FIG. 4 illustrates an example environment in which multiple computing nodes have access to multiple memory resources across multiple memory devices. Moreover, FIG. 5 provides an example environment similar to the environment described in FIG. 2 with additional detail in connection with a memory ranking system on a computing device.

While these different environments showing different implementations of devices illustrate a variety of features and functionality in connection with managing memory access, tracking memory usage data, and maintaining heatmaps for one or multiple accessing agents, it will be understood that features and functionality of components described in connection with the respective computing nodes and/or memory devices may apply to any of the illustrated implementations. In particular, features described in connection with the more detailed implementation shown in FIG. 2 and/or FIG. 5 may apply to either of the implementations described in connection with FIGS. 1 and/or FIG. 4.

For example, FIG. 1 illustrates an example environment 100 including a plurality of computing nodes 102a-n and a memory device(s) 101. As shown in FIG. 1, the environment 100 may include any number of computing nodes 102a-n having access to a memory resource 118 on the memory device(s) 101. In addition, while not shown in FIG. 1, the memory device(s) 101 may include multiple memory devices that provide a memory resource to each of the computing nodes 102a-n and accessing agent(s) thereon.

As shown in FIG. 1, the computing nodes 102a-n may include a variety of components thereon. By way of example and not limitation, a first computing node 102a-n may include a memory ranking system 104a and one or more virtual machines 106a. Additional computing nodes 102b-n may include similar components 104-106 thereon. One or more of the computing nodes 102a-n may additionally include local memory thereon, which may have lower latency speeds than the memory resource 118 on the memory device(s) 101. While additional detail will be discussed in connection with the memory ranking system 104a and virtual machine(s) 106a on the first computing node 102a, it will be understood that similar components on the additional computing nodes 102b-n may have similar features and functionality.

As further shown in FIG. 1, memory device(s) 101 may include a memory controller system 110. The memory controller system 110 may include a memory access manager 112, a heatmap manager 114 having heatmap(s) 116 thereon, and an accessible memory resource 118. As further shown, the memory resource 118 may include any number of memory segments 120 including chunks of memory that are accessible to the computing nodes 102a-n.

In one or more embodiments, the memory controller system 110 may refer to a compute express link (CXL) memory controller. The CXL memory controller may include a CXL 2.0 compliant device configured for disaggregated memory usage. As will be discussed in further detail below, one or more embodiments of the memory controller 110 may provide a memory resource for up to eight independent hosts without the need for a CXL switch.

As will be discussed below, the memory ranking system 104a and the memory control system 110 can cooperatively provide features and functionality described herein in connection with providing memory resources to any number of accessing agents (e.g., computing nodes 102a-n, virtual machines 106a-n, applications). In addition, memory ranking system 104a and the memory control system 110 can cooperatively provide features and functionality in connection with generating and maintaining heatmaps, selectively accessing heatmaps for respective accessing agents, and compiling heatmaps over time in accordance with one or more embodiments.

Additional detail in connection with respective components (and sub-components) of the computing nodes 102a-n and the memory device 101 will be discussed in further detail in connection with FIG. 2. In particular, FIG. 2 shows a more detailed example of a computing node 102 and the memory device 101, which may be example implements of similar components included within the environment 100 shown in FIG. 1. For example, the computing node 102 may include similar features as any of the computing nodes 102a-n shown in FIG. 1.

While FIG. 2 illustrates an environment in which the computing node 102 and the memory device 101 are distinct devices, it will be understood that the memory device 101 may be implemented as a subcomponent of the computing node 102 or on a separate device as the computing node 102. Indeed, the memory resource 118 may refer to a local memory resource on the computing node 102, a remote memory resource for the computing node 102, or a pooled memory resource for the computing node 102 and any number of additional accessing agents. Moreover, the memory resource 118 may serve as a primary memory source for the computing node 102 or, alternatively, as a supplemental memory source that augments memory capacity of the computing node 102 having a separate memory source (e.g., a local memory) implemented thereon. Accordingly, features described in connection with FIG. 2 may be applicable to other environments of a memory resource 118 accessible to one or multiple accessing agents managed by a memory controller system 110.

As mentioned above, the memory ranking system 104 and the memory controller system 110 may cooperatively facilitate access to a memory resource 118 on the memory device 101. In particular, the computing node 102 may access the memory resource 118 in a variety of ways. For example, the computing node 102 can read, write, or otherwise access data from a particular memory segment that has been allocated or otherwise associated with the computing node 102 such that the computing node 102 has exclusive access to the memory segment. In one or more embodiments, the virtual machine(s) 106, applications, or other accessing agents can selectively access memory segments 120 on the memory resource 118.

In particular, as mentioned above, the memory controller system 110 may include a memory access manager 112 that manages access to memory segments 120 of the memory resource 118. In one or more embodiments, the memory access manager 112 associates one or more of the memory segments 120 with respective accessing agents. For example, where a memory segment has been allocated for use by the computing node 102, the computing node 102 may have exclusive access to the memory segment. Accordingly, the memory controller system 110 may only provide access to the allocated memory segment to the specific computing node 102. In one or more embodiments, the memory controller system 110 allocates multiple segments (e.g., contiguous or non-contiguous segments) on the memory resource 118 such that the computing node 102 may selectively access those memory segments without accessing other segments from the memory resource 118.

Thus, in one or more embodiments, the memory controller system 110 provides selective access to one or more memory segments from a collection of memory segments 120 on the memory resource 118 of the memory device(s) 101. For example, where eight nodes each have access to the memory resource 118, the memory access manager 112 can provide selective access to eight different subsegments of the memory segments 120 depending on associations of the memory segments with each of the respective computing nodes. In one or more embodiments, the memory controller system 110 controls memory access for each of the computing nodes by maintaining associations between host identifiers (e.g., identifiers of computing nodes or other accessing agents) and corresponding segment addresses. As further shown, in one or more embodiments, the computing node 102 maintains address data or other memory controller data that enables the computing node 102 to provide an indication of a memory segment address (or other identifier of the memory resource 118) in order to access the relevant memory segment(s). Additional detail in connection with managing access to respective memory segments by the computing node 102 will be discussed below in connection with FIG. 3.

As indicated above, in one or more embodiments, the computing node 102 maintains a local memory resource that supplements the memory resource 118 on the memory device 101. In one or more embodiments, the computing node 102 maintains respective portions of data on either the local memory or the memory resource 118 based on a variety of criteria. For example, in one or more embodiments, the computing node 102 maintains critical data or system data within a local memory to ensure reliable access or faster access speeds relative to the data maintained within the memory resource 118. As another example, the computing node 102 may maintain data on either the local memory or the memory resource 118 based on memory usage data collected from the memory device 101. Indeed, the computing node 102 may consider a variety of criteria in determining which portion of data should be maintained between the local or memory resource 118, examples of which will be discussed in further detail herein.

In addition to maintaining data and enabling the computing node 102 to access relevant portions of data, the systems described herein can facilitate tracking interactions (e.g., access instances) with the memory resource 118 and maintaining heatmaps 116 for different portions of memory resources. As used herein, “memory accesses” or “access instances” may refer to any instance in which a computing node, virtual machine, application, or other accessing agent reads, writes, edits, deletes, or otherwise interacts with a memory segment. For example, a single read may refer to a single access instance while a read and a write may refer to two separate access instances. In addition, a stream of access instances may refer to a burst of any number of access instances (e.g., 100s or 1000s of access instances) within a brief period of time.

As mentioned above, the memory controller system 110 can track access instances in a variety of ways. In particular, as mentioned above, and as shown in FIG. 2, the memory controller system 110 can include a heatmap manager 114 that tracks a variety of metrics associated with one or more access instances. In addition, and as will be discussed in further detail below, the memory controller system 110 may track access instances with respect to each of the memory segments 120 on the memory resource 118. Further, where a memory environment (e.g., a pooled memory environment) includes multiple memory devices, each device may include a memory controller system thereon that performs similar features with respect to tracking access instances on memory segments of memory resources thereon.

In one or more embodiments, tracking access instances involves simply detecting that an access instance has happened. For example, in one or more embodiments, the memory controller system 110 maintains a frequency metric (e.g., a frequency count) for each memory segment of the memory resource 118. Upon detecting any access of a memory segment, the memory controller system 110 iterates the frequency counter for the memory segment. In one or more embodiments, the frequency counter includes a saturating counter limited in size based on a number of bits used to represent the frequency metric.

In one or more embodiments, upon identifying or otherwise associating a memory segment with a corresponding accessing agent, the memory controller system 110 can initialize a frequency count to zero. The memory controller system 110 can then increment the frequency count with each detected access. As will be discussed in further detail below, the memory controller system 110 can reset or clear the frequency count in response to reading the associated segment entry. Further, upon evicting or otherwise removing a memory segment from the memory resource 118, the memory controller system 110 can remove the corresponding heatmap from the collection of heatmaps 116. Additional features and functionality in connection with generating and maintaining a frequency metric for corresponding memory segments will be discussed in further detail below in connection with FIG. 3.

In addition to tracking frequency of memory access, the memory controller system 110 can additionally collect or otherwise track additional information in connection with the access instances. For example, the memory controller system 110 can log a time or recency metric associated with an access instance. In one or more embodiments, the memory controller system 110 tracks recency of memory access instances by generating or providing a global access count that tracks a total number of interactions (e.g., access instances) with the memory resource 118. More specifically, the memory controller system 110 can detect any access to any of the memory segments 120 (e.g., by any accessing agent) and iterate a global counter in response to the detected access. The memory controller system 110 can use the global counter to track a most recent access with respect to a given memory segment by copying the global counter value to a segment entry within the heatmap in conjunction with the frequency data.

As an illustrative example, where the memory controller system 110 detects an access instance for a memory segment associated with a first segment entry 212a, the memory controller system 110 can first iterate a frequency counter for the first segment entry 212a to track and maintain the frequency metric. Further, the memory controller system 110 can copy a value from the global counter and store the count alongside the current value of the frequency counter. In this way, the memory controller system 110 can track values reflective of both a frequency with which the corresponding segment is being tracked as well as how recently the memory segment was last accessed. Additional information in connection with tracking frequency and recency data will be discussed below in connection with an illustrative example shown in FIG. 3.

In addition to tracking frequency and recency, the memory controller system 110 can track or otherwise identify a portion of a memory segment that has been interacted with by the computing node 102 (or another accessing agent). For example, as discussed above, the memory segments 120 may differ significantly in size from one another. For instance, one memory segment associated with a corresponding heatmap entry may include only 4 KB of data while another memory segment associated with another heatmap entry may include 2 MB of data. Moreover, it may be possible that only a small portion of the 2 MB memory segment is being accessed while access trends for other portions are relatively static.

In one or more embodiments, the memory controller system 110 facilitates tracking density data indicative of select portions of the memory segment(s) that are being accessed more frequently or recently than others. For example, the memory controller system 110 can generate and maintain density data including values representative of whether specific portions or sub-segments of the respective memory segments are being accessed. In one or more embodiments, the memory controller system 110 maintains a density bit (or other set of values) in which each bit of a multi-bit sequence represents a corresponding portion or subset of data from a memory segment. Further, in one or more embodiments, the memory controller system 110 tracks which portion of a memory segment has been accessed and iterates a corresponding value from the density bit accordingly.

As an example, where a density value includes eight bits representative of eight portions of a corresponding memory segment, the memory controller system 110 can determine which of the eight portions of the memory segment has been accessed and iterate the corresponding bit from the density value to reflect the access instance. Accordingly, where only a single portion of the memory segment is being accessed over and over again, the memory controller system 110 can track density data indicating the select memory segment that is hot (e.g., frequently and/or recently accessed) relative to other portions of the memory segment. Alternatively, where multiple portions of the memory segment are being accessed over and over again, the memory controller system 110 can track this frequency information by causing the density data to reflect this within the segment entry for the heatmap.

In one or more embodiments, the density value(s) differs in length and detail based on a size of a corresponding memory segment. For example, where a first memory segment is significantly smaller in size than a second memory segment, the memory controller system 110 may generate a density value having fewer values representative of the first memory segment than the second memory segment. For instance, a 4 KB memory segment may have fewer associated density bits than a 1 MB or 100 MB memory segment. In one or more embodiments, the size of the density value is a function of how many bits are needed to indicate a memory address or identifier of a memory segment, which would require more bits for memory segments of smaller sizes than memory segments of larger sizes. Indeed, in one or more embodiments, the size of a density bit may range from 8 bits to 20 bits based on a size of the corresponding memory segment. In one or more implementations, the density bit may be one of 8 bits or 16 bits, depending on a configuration of the memory controller system 110. Additional detail in connection with illustrative embodiments is discussed in further detail below in connection with FIG. 3.

As further shown in FIG. 2, the memory controller system 110 can track decay data. The decay data may indicate additional information about a frequency and/or recency of access instances. For example, where a memory segment is particularly hot (e.g., where the memory segment is being accessed with high frequency), a mechanism for tracking the frequency may become saturated. For instance, where a frequency bit only includes eight bits of data, and where a memory segment has been accessed more than 256 times without being cleared, the memory controller system 110 can maintain an additional one or more decay values (e.g., decay bit(s)) to indicate a saturation level of the frequency data. In one or more embodiments, the memory controller system 110 decay data indicating a decay rate or other metric providing an additional metric of frequency with respect to memory segments. Further examples of tracking and maintaining decay data will be discussed below in connection with FIG. 3.

As noted above, and as shown in FIG. 2, the memory controller system 110 can additionally maintain any or all of the tracked information within corresponding segment entries 212a-n. In particular, the heatmap manager 114 can maintain tracked memory usage data for each memory segment of the memory resource 118. As noted above, above, the memory usage data can include access metrics including some or all of frequency data, recency data, density data, and decay data with respect to each of the memory segments 120.

As shown in FIG. 2, the memory controller system 110 can maintain a heatmap for each accessing agent. Accordingly, in the example shown in FIG. 2, each of the heatmaps 210a-n may include memory usage data for each of multiple computing nodes. In addition, or as an alternative, the memory controller system 110 can maintain a heatmap for each of multiple virtual machines 106 on the computing node 102 (or across multiple computing nodes). Indeed, as shown in FIG. 2, the memory controller system 110 can maintain any number of heatmaps 210a-n corresponding to any number of accessing agents having access to the memory resource 118.

As shown in FIG. 2, each of the heatmaps 210a-n may include one or more segment entries 212a-n. In particular, each of the heatmaps 210a-n may include segment entries 212a-n corresponding to respective memory segments 120 of the memory resource 118. Indeed, the memory controller system 110 can maintain a heatmap entry for each memory segment 120 within a corresponding one of the plurality of heatmaps 210a-n depending on which node or other accessing agent with which each of the memory segments 120 are associated.

As an illustrative example, FIG. 2 shows a first heatmap 210a, which may be associated with the computing node 102. As shown in FIG. 2, the first heatmap 210a may include a plurality of segment entries 212a. Each of the segment entries 212a may include memory usage data for each of the corresponding memory segments from the memory resource 118 with which the computing node 102 is associated. In one or more embodiments, the segment entries 212a include memory usage data for any number of memory segments from the memory resource 118 with which the computing node 102 has previously interacted.

As discussed above, and as shown in FIG. 2, each of the segment entries 212a may include a variety of different access metrics associated with access instances that have been tracked by the memory controller system 110. In particular, as shown in FIG. 2, the access metrics 214a for the first heatmap 210a may include various metrics, such as frequency data, recency data, density data, and decay data. These particular metrics 214a are provided by way of example, and some or all of the heatmaps may include additional or fewer access metrics, depending on capabilities and/or configurations of the memory controller system 110.

The memory controller system 110 may maintain the segment entries in a variety of ways. For example, in one or more embodiments, each of the heatmaps 210a-n are represented by a table having a depth and width corresponding to information contained therein. For example, the heatmaps 210a-n may include heatmap tables in which each row represents a corresponding segment entry and sets of bits or values within the rows are representative of corresponding access metrics. Accordingly, a depth of a heatmap would correspond to a number of rows while a width of the heatmap refers to a number of metrics or bit values representative of the access metrics. Additional information in connection illustrative examples will be discussed below in connection with FIG. 3.

In addition to tracking the access instances and maintaining the heatmaps, the memory controller system 110 can additionally provide access to the heatmaps to the computing node 102 (and other computing nodes in communication with the memory device 101). In particular, the heatmap manager 114 and the heatmap access manager 202 can cooperatively enable access to the memory usage data maintained within the respective heatmaps 210a-n.

In one or more embodiments, the memory ranking system 104 reads one or more of the heatmaps 116 by sending a request to the memory controller system 110. In one or more embodiments, the heatmap access manager 202 reads the memory usage data by performing a memory-mapped input/output (MMIO) read on the memory controller system 110. This enables the heatmap access manager 202 to obtain access to select heatmaps 116, such as a set of segment entries within a heatmap corresponding to the computing node 102. As will be discussed in further detail below, submitting a request by performing an MMIO read enables the computing node 102 to perform a single 8-byte read for each segment entry within a given heatmap.

In one or more embodiments, reading the heatmaps 116 causes all counters and bit values associated with the read to reset to zero. For example, where the memory ranking system 104 performs a read of a first heatmap 210a, each of a plurality of segment entries 212a within the first heatmap 210a may be cleared to zero. Similarly, each of the heatmaps 210a-n may be cleared to zero each time a respective heatmap is read. By clearing the counters and data in this way, the memory controller system 110 can prevent or reduce instances of counters from saturating, thus ensuring that the data contained within the segment entries are useful and relevant. The memory ranking system 104 can facilitate reading the heatmaps 116 at any level of granularity. By way of example, the memory ranking system 104 can read the memory usage data from a relevant heatmap once every second, two seconds, or other predetermined interval.

Upon reading the memory usage data associated with the computing node 102, the memory ranking system 104 can collate or otherwise compile the collected data. In particular, in one or more embodiments, the memory ranking system 104 (e.g., heatmap access manager 202) can collate the data from a heatmap with previously read memory usage data. For example, upon performing each read, the memory ranking system 104 can collate the memory usage data and generate a comprehensive representation of the memory usage data over time.

In one or more embodiments, where the memory ranking system 104 performs a read of heatmaps periodically, the memory ranking system 104 can combine each periodic read with previously read heatmaps. For example, the memory ranking system 104 can append each subsequent read to generate a log of heatmap reads. In one or more embodiments, the heatmap classification manager 204 further processes the memory usage data to generate a representation of heatmap trends or usage data over time with respect to one or more memory segments.

In addition to simply combining memory usage data for a memory resource 118, the memory ranking system 104 can combine memory usage data for memory across a plurality of memory devices. For example, where the computing node 102 is in communication with and has access to memory resources across a variety of memory devices, the memory ranking system 104 can further combine the memory usage data to generate a representation of memory hotness across multiple memory devices. Additional features in connection with an example implementation in which multiple computing nodes have access to multiple memory devices is discussed below in connection with FIG. 4.

In one or more embodiments, the heatmap classification manager 204 can provide access to the combined memory usage data to various application, virtual machines, or other services hosted by the computing node 102 to accomplish a variety of functions and benefits. By combining the memory usage data in this fashion, the memory ranking system 104 can accurately determine which of a plurality of memory segments are hotter (e.g., more frequency and/or recently used) than other memory segments.

Moreover, by collecting and maintaining a variety of access metrics as discussed above, the memory ranking system 104 can perform a variety of useful functions to facilitate higher performance of the computing node 102. For example, by considering not only frequency of access (e.g., based on a combination of a frequency bit and a density bit), but recency of access and density of access, the memory ranking system 104 can determine a metric of segment hotness or memory hotness to enable the memory ranking system 104 to accurately determine which of the memory segments should be further considered for migration from the memory resource 118 to a local memory having faster access speeds.

In addition to reorganizing chunks of data between local and shared systems, the computing node 102 can utilize the memory usage information to make various decisions. For example, the memory ranking system 104 can consider other memory management functions such as memory replication, memory relocation between memory sources, dividing and/or combining data between memory segments, or other policy or application-based decisions with respect to management of the memory. Moreover, in one or more embodiments, the memory ranking system 104 causes the memory usage data to be shared with different applications, virtual machines, or other services in a variety of ways (e.g., based on unique configurations of the respective applications/services). In each of these examples, collecting additional information beyond a simple metric of whether a memory segment has been read and/or modified provides important information that enables various systems to more efficiently utilize memory resources to improve performance of a computing node and/or applications or services running on the computing node.

Moving on, FIG. 3 provides an example implementation of a memory controller system 110 in accordance with one or more embodiments described herein. As shown in FIG. 3, the memory controller system 110 includes a plurality of stages, each of which may include a combination of hardware and software components to perform features and functionality described herein. In particular, as shown in FIG. 3, the memory controller system 110 may include an upstream port communication stage 302, a remapping block stage 304, and a memory control stage 310. Additional detail will now be given in connection with each of the respective stages of the memory controller system 110.

The upstream port communication stage 302 may include hardware and circuitry components that enable communication between the memory controller system 110 and one or more computing nodes. In one or more embodiments, the upstream port communication stage 302 includes interface logic to a compute express link (CXL) bus. This interface logic may provide a serial interface having a configurable number of lanes for the CXL bus (e.g., four, six, eight lanes). Indeed, the upstream port communication stage 302 may include any number of CXL ports including a plurality of receiver and transmission ports that facilitate communication between the memory controller system 110 and one or more computing devices or other accessing agents. In connection with one or more embodiments described herein, the upstream port communication stage 302 can receive and process transactions (e.g., memory read or write requests) and convert them to a format capable of being sent through hardware of the memory controller system 110.

The remapping block stage 304 can manage access to memory resources as well as access to heatmaps 306 including memory usage data maintained thereon. In connection with managing access to memory resources, the remapping block stage 304 can receive requests relayed by hardware of the upstream port communication stage 302 from any number of hosts (e.g., eight hosts, corresponding to a number of CXL ports). The requests for memory access may include a host identifier (e.g., an identifier of a computing node and/or accessing agent) and a memory address. The remapping block stage 304 can remap the address to a contiguous address block. In short, the remapping block stage 304 can disambiguate requests and map those requests to corresponding segments of memory. In this way, the remapping block stage 304 can provide access to fine-grained chunks of memory to the computing node(s).

As shown in FIG. 3, the memory control stage 310 can host memory devices, which may include any type volatile memory type. In this example, the memory control stage 310 can include double data rate (DDR) bus controllers that enable access to a plurality of DRAM blocks 312. As indicated above, other types of memory hardware may be used in providing memory to computing nodes. As an example, in one or more embodiments, the memory control stage 310 includes controllers and corresponding DIMM devices.

In addition to providing access to memory the memory controller system 110 can provide access to the heatmaps 306. For example, the upstream port communication stage 302 can receive a request to access heatmaps 306 and the remapping block stage 304 can process the request and provide access to select portions (e.g., individual heatmaps, segment entries) of the heatmap 306.

In one or more embodiments, requests for memory access and requests for heatmap access are provided by way of different protocols and are processed on different access paths. For example, in one or more embodiments, a request for memory is provided via a CXL.mem protocol while a request for heatmaps 306 is provided via a CXL.io protocol (or other similar protocol). In addition to utilizing different types of protocols, the respective request types can be processed on different paths. For instance, where the requests for memory access are processed on critical paths or higher performing paths that operate on an order of nanoseconds, the requests for heatmap access can be multiplexed through the remapping block stage 304 and provided as register reads to read content of the heatmaps 306 using a less critical or slower read process.

Further, requests for reading heatmaps 306 may be provided via a non-critical path that is different than an access path of the memory reads. By processing heatmap reads on a different non-critical path from the memory reads, the remapping block stage 304 can provide access to a register containing the heatmaps 306 without detrimentally interfering with memory access speeds on the memory controller system 110. Thus, the remapping block stage 304 can provide access to the heatmaps 306 without incurring a latency penalty on the loads and stores, which are independently going to the DRAM attached to the CXL memory controller via a critical path. Moreover, in one or more embodiments, the loads and stores (e.g., memory reads) are coming from virtual machines or other applications that access the memory resources while the heatmaps 306 are polled by a host operating system on the computing node (or other privileged software entity at a layer below the source of individual access).

In accordance with one or more embodiments described above, the heatmaps 306 may include a variety of different access metrics therein. In the example shown in FIG. 3, the heatmaps 306 illustrates an example set of heatmaps corresponding to associated accessing agents. For example, as shown in FIG. 3, the remapping block stage 304 can maintain a heatmap including a table of access metrics for each of multiple accessing agents.

As shown, the heatmaps may include tables having rows and columns of data. In the illustrative example shown in FIG. 3, a first column may include a list of entry identifiers associated with corresponding memory segments. The second column may include a frequency value for each memory segment. The third column may include a decay value for each memory segment. The fourth column may include a recency value bit for each memory segment. The fifth column may include a density value for each memory segment. Each of these values may refer to bit vectors or bit-sequences of various sizes.

Each of the rows of the tables may refer to an example segment entry in accordance with one or more embodiments described herein. Thus, each row of the table may correspond to a specific memory segment where each memory segment represented within the table is associated with a corresponding computing node (or other accessing agent).

As a first example, a first segment entry includes an entry identifier of “0x0000 . . . D013” referring to an address of a corresponding memory segment. A length of the entry identifier may depend on a size or granularity of the corresponding memory segment. For example, where a memory segment is 4 KB long, a large number of bits (e.g., 40 bits) of data may be needed to accurately identify a location of the memory segment on the memory block(s). Alternatively, where a memory segment is 2 MB, fewer bits (e.g., 28 bits) of data may be needed to identify a location of the memory segment. Accordingly, this entry identifier of the first segment entry may have a corresponding length based on a size of the memory segment.

As further shown, the first segment entry may include eight bits representative of a frequency access metric and eight bits representative of a decay access metric. Other implementations may include fewer or additional bits to represent frequency and/or decay of the memory segment. In accordance with one or more embodiments discussed above, the frequency and decay bits may collectively provide an indication of a frequency with which the memory segment has been accessed between a current time (e.g., a time at which the heatmap is being accessed) and a most recent access of the table. To illustrate, in this first example, the frequency value reads “00000101” indicating (without considering the decay bit) that the memory segment has only been accessed a few times (e.g., five times) since the frequency value last read “00000000.” However, because the decay value reads “00011011,” it can be determined that the frequency counter has saturated several times, which indicates that the memory segment has been accessed significantly more than five times since the last time that the heatmap for the associated memory segment has been read (causing the segment entry to reset to zero).

As further shown, the first segment entry includes a recency value indicating a time when a most recent access instance occurred. In particular, as discussed above, the remapping block stage 304 may maintain a global counter that increments in response to each memory access of any memory segment by any computing node having access to the memory resource managed by the memory control system 110. While not necessarily a timestamp indicative of a specific date and time of access, this global counter may provide a notion of a timestamp or recency that a memory segment has been accessed relative to when other memory segments have been accessed.

In this example of the first segment entry, the recency value may read “00100010” corresponding to a value of the global counter when the last access instance was tracked and corresponding to when the frequency counter was last incremented. When compared to a current version of the global counter, this value of the recency bit can provide an indication of how recent the memory segment was last accessed. Where the recency value is close to or the same as the global counter, a memory ranking system 104 may determine that the memory segment was recently accessed (e.g., relative to other memory segments on the memory resource).

In one or more embodiments, recency counter values may be modified over time even where a memory segment is not read recently. For example, where a global counter reaches a maximum value (e.g., 2⁶⁴−1 where a recency counter has 64 bits), all existing recency counts may be halved or otherwise modified to prevent several different entries from sharing the same recency value. In one or more embodiments, the recency counter is not exposed to the software that accesses the heatmaps 306. Accordingly, the recency counter may not be constrained to a particular size or length similar to the access metrics contained within the heatmap tables.

As further shown in FIG. 3, the first segment entry may include a density bit. In this example, the density value includes eight bits that read “01011111” indicating that six out of eight sub-segments of the corresponding memory segment has been accessed since values of the table were last cleared (e.g., as a result of a heatmap read). In one or more embodiments, each of the bits within the density value represents one-eighth of the memory segment. While this example shows an example density bit having eight bits, other sized density values can have fewer or additional lengths corresponding to different levels of granularity.

For example, in accordance with one or more embodiments described above, the density value may have a length based on a size of the entry identifier. For example, where the entry identifier is longer (e.g., corresponding to a smaller-sized memory segment), the density value may also be shorter than other density values. Alternatively, where the entry identifier is shorter (e.g., corresponding to a larger-sized memory segment), the density value may be longer than other density values to provide additional granularity in how densely the memory segment is being interacted with over time.

In one or more embodiments, the length of the segment entries is 8 bytes (or 64 bits) corresponding to a length of a single MMIO read. Maintaining segment entries at this size enables a computing node to quickly access the heatmaps 306 because each segment entry may be read within a single MMIO read. Accordingly, an entire heatmap can be read using as many MMIO reads as there are rows within the heatmap table. Because MMIO is a serializing operation, which can become expensive, reducing the number of reads needed to obtain information from the heatmaps 306 can provide beneficial results. For example, by maintaining segment entries of this length, the heatmaps 306 can be read more frequently without negatively impacting memory read performance, thus enabling the computing node to gather more comprehensive and more detailed memory usage information.

As indicated above, while the frequency value, decay value, and recency value may have uniform or standard values across each of the segment entries, the density value may vary in length based on a size of the corresponding entry identifier. In one or more embodiments, a combined number of bits that the entry identifier and the density access is forty-eight bits. Accordingly, where a memory segment is 4 KB long and requires forty bits to identify a memory address, the density value may include eight bits. Alternatively, where a memory segment is 2 MB long and requires only twenty-eight bits, the density value may utilize up to twelve additional bits to provide more detailed information about where on a memory segment the memory is being read.

In one or more embodiments, the density value includes some multiple of eight bits. For example, in one or more implementations, the density value includes eight bits when a corresponding memory segment size is between 4 KB and 2 MB. In this example, the density value may include sixteen bits when a corresponding memory segment is between 2 MB and 1 GB. Other thresholds may be used in determining a size of the density value.

In one or more implementations, one or more of the heatmaps are partitioned into n-number of partitions with the number (n) of partitions being associated with software context within one or more computing nodes. For instance, where a heatmap has 512 (or some other number) of entries per computing node, the 512 entries may be partitioned in a variety of ways. As an example, where a computing node has eight virtual machines, applications, or other accessing agents implemented thereon, in order to avoid one virtual machine from polluting access data from another virtual machine, the 512 entries of the heatmap may be partitioned into eight partitions of sixty-four entries where each virtual machine traffic would be tracked using sixty-four entries. Other implementations may have different numbers of partitions and/or different sizes of partitions, for example, in accordance with pre-configured address ranges of a memory controller. Moreover, in one or more implementations, the partitions may be of equal or not equal sizes. For example, one or more virtual machines may be associated with larger or smaller partitions than one or more additional virtual machines.

FIG. 4 illustrates another example implementation of an environment including a plurality of computing devices (e.g., server nodes 402a-c) having access to a plurality of pooled memory devices 408a-c. Each of the server nodes 402a-c may include similar features and functionality as the computing nodes 102a-n discussed above in connection with FIG. 1. Similarly, each of the pooled memory devices 408a-c may have similar features and functionality as the memory device(s) 101 discussed in connection with FIGS. 1-3. In one or more embodiments, the environment 400 refers to a portion of a cloud computing system (or other network of computing devices).

As shown in FIG. 4, the server nodes 402a-c may include memory ranking systems 404a-c and local memory systems 406a-c (e.g., local memories managed by local systems on the server nodes 402a-c). In addition, the pooled memory devices 408a-c may include memory controller systems 410a-c having heatmaps 412a-c and pooled memory 414a-c thereon. Each of the components shown in FIG. 4 may have similar features and functionality as corresponding components discussed above in connection with one or more embodiments.

As shown in this example, each of the server nodes 402a-c may have access to each of the pooled memory devices 408a-c. Thus, in one or more embodiments, the first server node 402a may have access to memory segments across each of the pooled memories 414a-c on the respective memory controller systems 410a-c. Because the first server node 402a has access to memory segments on each of the pooled memory devices 408a-c, each of the memory controller systems 410a-c may maintain memory usage data for the first server node 402a (and/or any of multiple accessing agents on the first server node 402a).

Thus, when reading the heatmaps 412a for the server node 402a, the memory ranking system 404a can collate or otherwise combine memory usage data from different heatmaps on the multiple pooled memory devices 408a-c. In one or more embodiments, the memory ranking system 404a makes determinations of hotness for the different memory usage data based on different combinations of access metrics tracked by each of the memory controller systems 410a-c. It will be appreciated that the additional server nodes 402b-c may similarly collect and collate memory usage data from each of the memory controller systems 410a-c.

While the memory controller systems 410a-c may refer to identical or similar systems having similar or identical functionality as one-another, in one or more embodiments, the memory controller systems 410a-c have one or more differences in capabilities. For example, where a first memory controller system 410a may track each of the above-discussed access metrics (e.g., frequency, decay, recency, density), the second and/or third memory controller systems 410b-c may not have a capability to track one or more of the access metrics. For example, one or more of the memory controller systems may be an older generation device that does not track and maintain recency or density metrics, and thus provide a limited view of memory usage data relative to newer or higher capability versions of the memory controller systems. In this example, the memory ranking systems 404a-c may nonetheless combine the memory usage data from the disparate heatmaps and account for the different available data with respect to certain memory segments.

In addition, it will be noted that, in one or more embodiments, the memory controller systems 410a-c are unaware of one another. Thus, while the server nodes 402a-c may have access to each of the pooled memory 414a-c on the pooled memory devices 408a-c, the pooled memory devices 408a-c may have no communication with one another to compare notions of hotness with respect to various memory segments. Moreover, global recency counters may not necessarily have consistent notions of how frequency or recently access instances across pooled memory devices 408a-c have occurred across the pooled memory devices 408a-c. Accordingly, in one or more embodiments, the memory ranking systems 404a-c can apply one or more models and analyses of the collected memory usage data to determine and compare hotness of memory data between the different pooled memory devices.

In addition, while FIG. 4 illustrates an example environment 400 including three server nodes 402a-c and three pooled memory devices 408a-c, the environment may include additional or fewer devices and associated components. For example, in one or more embodiments, the pooled memory environment includes eight computing nodes in communication with one or more (e.g., eight) pooled memory devices. In this example, the pooled memory devices may be limited based on a number of upstream ports or a CXL bus interface between the memory controller systems and the corresponding computing nodes.

While one or more embodiments described herein describe features of a memory controller system in which a memory controller manages access to a memory resource and facilitates tracking memory usage data thereon, it will be understood that one or more embodiments of the memory controller systems may include multiple memory controller devices that operate independently and independently provide access to corresponding memory resources. This may be applicable, for instance, where a processor includes multiple memory controllers on a machine. The memory ranking system on the computing nodes may then aggregate memory usage data obtained via multiple memory controllers on the respective computing node(s) to provide a view of available memory resources accessible to the computing node(s).

Turning now to FIG. 5, this figure illustrates another example environment 500 including a computing device 502 and a memory device 501 in accordance with one or more embodiments described herein. Indeed, the computing device 502 and the memory device 501 may include similar features and functionality as similar elements and components described above. For example, the memory device 501 may include a memory controller 524 that manages access to memory segments 528 of a memory resource 526. The memory controller 524 may generate and maintain heatmaps for any number of accessing agents in accordance with examples described above. Moreover, while FIG. 5 shows an example environment 500 including a single memory device 501, features described herein in connection with the memory ranking system 504 may similarly apply to interactions between the computing device 502 and multiple memory controllers on the same or across multiple memory devices, including pooled or non-pooled memory devices.

As shown in FIG. 5, the computing device 502 may include a memory ranking system 504 having a heatmap accessing manager 506 and a heatmap classification manager 508. Each of the heatmap accessing manager 506 and a heatmap classification manager 508 may provide similar features and functionality of similar components described above. As further shown, the computing device 502 may include a local memory system 522 thereon. Additional features and functionality are discussed in connection with one or more embodiments below.

For example, as shown in FIG. 5, the heatmap access manager 506 may include a usage data collector 510. The usage data collector 510 may collect memory usage data from one or more memory controllers. For example, the usage data collector 510 may read a heatmap including access metrics associated with a set of memory segments accessible to the computing device 502 or other accessing agent (e.g., VMs 520) on the computing device 502. As discussed above, in one or more embodiments, the usage data collector 510 collects memory data by reading heatmaps across multiple memory devices (e.g., where the computing device 502 has access to memory resources controlled by the different memory controllers).

In one or more embodiments, the usage data collector 510 collects memory samples at periodic time intervals. For example, the usage data collector 510 may sample or read a heatmap at a variety of time intervals (e.g., 1 second, 2 seconds, 5 seconds) in accordance with a device or application policy. Indeed, as will be discussed in further detail below, the usage data collector 510 can sample memory usage data at a particular access frequency based on an indicated resolution or granularity of an application or other accessing agent.

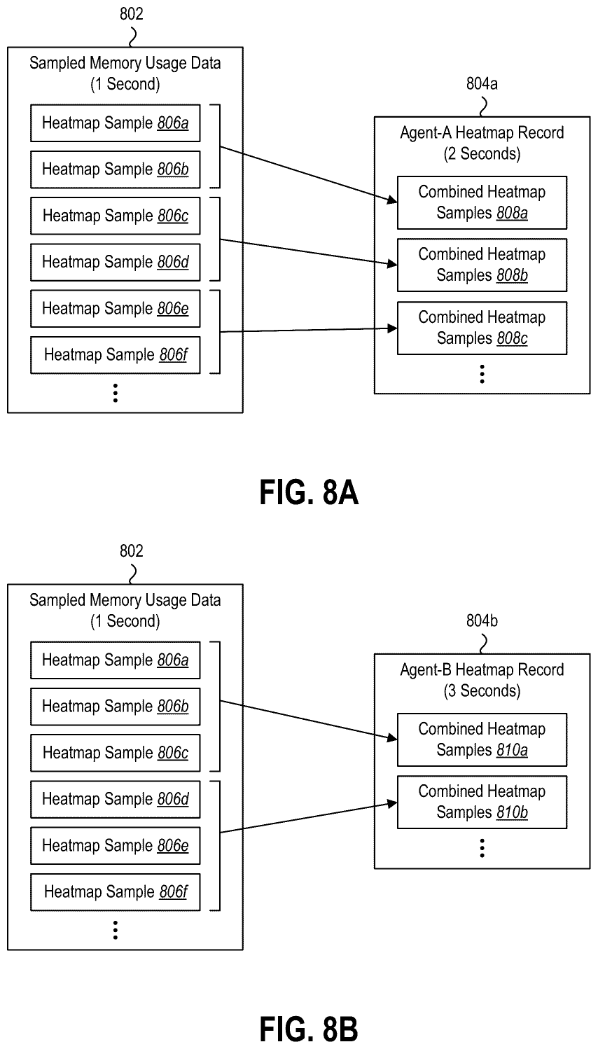

In one or more embodiments, the usage data collector 510 can determine an interval at which to collect or sample memory usage data. For instance, the usage data collector 510 may determine a sample granularity that includes an access frequency that accommodates disparate access resolutions for multiple accessing agents. Indeed, as indicated above, one or more applications may have different access resolutions that indicate disparate time intervals or frequencies that a heatmap should be read to accommodate one or more features of the application(s). In one or more embodiments, the usage data collector 510 can determine an access granularity based on a common factor of the different time intervals or frequencies in such a way that enables data to be shared with each of the multiple applications as if the applications associated with the respective access resolutions read the heatmaps themselves. Additional information in connection with sampling the memory usage data based on disparate access resolutions will be discussed below in connection with FIG. 8.

As further shown in FIG. 5, the heatmap access manager 506 may include a usage data compiler 512. As will be discussed in connection with one or more examples below, the usage data compiler 512 can combine memory usage data in a variety of ways.

For example, in one or more implementations, the usage data compiler 512 compiles data from multiple heatmap reads over time. For instance, where a heatmap associated with a set of memory segments is read every one second (or at some other interval), the usage data compiler 512 may combine sequential reads to generate trends of access metrics over time. For example, frequency metrics for each heatmap read may be compiled over time to provide a total number of access instances over different lengths of time. Similarly, recency metrics for each heatmap may be combined to identify that a memory segment is not only accessed in quick bursts, but regularly over time. Moreover, density metrics from sequentially read heatmaps may provide an indication of access density for different portions of the memory segments over time. As will be discussed in further detail below, these metrics may be considered alone and in combination with one another to determine overall trends of access and metrics of hotness for memory segments on one or more memory resources.

In addition to combining memory usage data from sequentially read heatmaps, the usage data compiler 512 may additionally combine data read from multiple heatmaps across multiple memory devices. For example, as discussed above, one or more implementations of the memory ranking system 504 may access memory segments across memory resources on multiple computing devices. In these cases, each of multiple memory controllers may independently maintain heatmaps for memory segments on the respective memory resources. Thus, the usage data compiler 512 may perform parallel heatmap reads or perform heatmap reads one after another to collect memory usage data from heatmaps maintained by the different memory controllers.

In this example, the usage data compiler 512 can generate a combined record of the memory usage data obtained from across the multiple memory controllers. For instance, in one or more embodiments, the usage data compiler 512 may generate a virtualization of the memory usage data to provide a combined view of a memory resource to an end-user, application, virtual machine, or other accessing entity that may have access to different memory resources across different devices. Indeed, in one or more implementations, the usage data compiler 512 provides a view of a combined memory source in a way that the accessing agent(s) are unaware that an accessible memory resource spans across multiple devices. In this way, the application, virtual machine, device, or other accessing agent need not be configured to distinguish between memory resources on different devices.

By combining memory usage data from heatmaps read across multiple memory controllers, the usage data compiler 512 additionally enables the computing device 502 to have access to tracked memory usage data even where the memory controllers that track and maintain the memory usage data have no knowledge of one another. For example, in one or more embodiments, the memory controllers are limited in tracking access metrics for only those memory segments on an associated memory pool. Nevertheless, by collating memory usage data read from multiple heatmaps, the usage data compiler 512 can combine the memory usage data and provide an overall picture of memory usage across multiple memory devices.

In one or more embodiments, the usage data compiler 512 may additionally combine tracked memory usage data even where memory usage data tracked by different memory controllers have different capabilities in tracking access metrics. For example, in one or more implementations, a first memory controller may track access frequency while a second memory controller tracks a combination of access frequency, access recency, and access density. In this example, the usage data compiler 512 may nonetheless generate a combined record including a table or other data structure in which access metrics for each of the different memory segments compiled. In one or more embodiments, the usage data compiler 512 may record and compile data as each heatmap access is performed. Additional information will be discussed below in connection with one or more examples.

As noted above, in one or more embodiments, the heatmap access manager 506 determines a frequency at which to sample memory usage data from one or more memory controllers. In particular, as discussed above, the usage data collector 510 may collect samples of memory usage data at a determined granularity based on diverse access resolutions for a plurality of accessing agents. As will be discussed in further detail below, in one or more implementations, the usage data compiler 512 can receive this sampled memory usage data and combine the data in such a way that enables multiple accessing agents to have access to memory usage data that is combined in such a way that simulates a particular access resolution of the respective accessing agents.

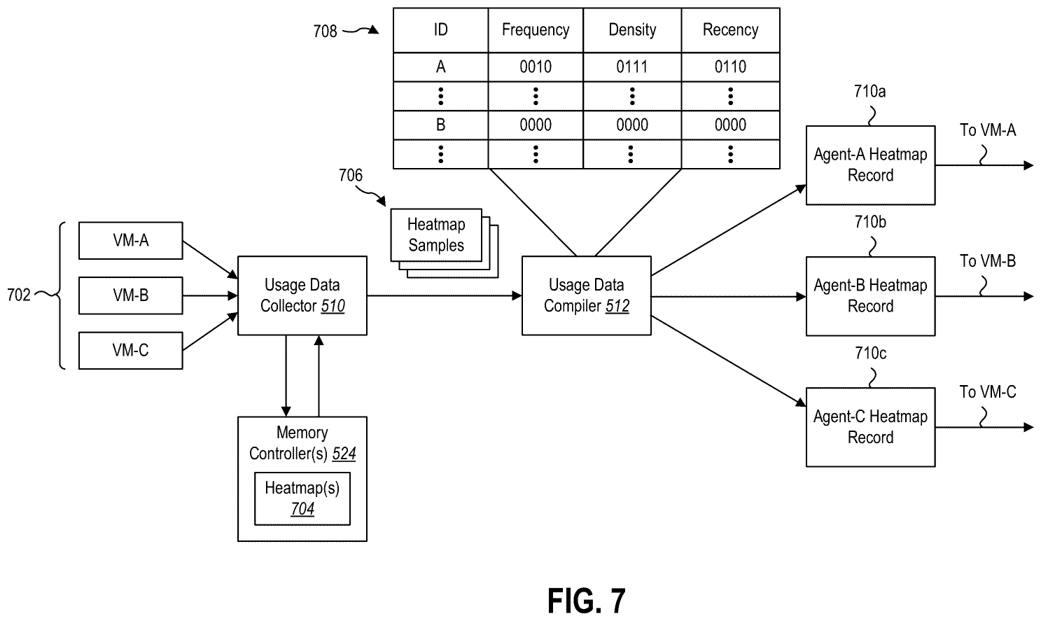

For example, and as will be discussed in further detail below, the usage data compiler 512 can combine samples of the memory usage data in accordance with different access resolutions for the different accessing agents. For example, in one or more embodiments, the usage data compiler 512 can generate agent-specific memory usage records that include different combinations of the memory usage data. Indeed, in one or more implementations, the usage data compiler 512 can generate an agent-specific memory usage record for each accessing agent based on unique access resolutions for the respective accessing agents. Additional detail in connection with collecting and combining sampled memory usage data (and sharing the data with respective accessing agents) will be discussed below in connection with FIGS. 7 and 8A-8B.

As mentioned above, and as shown in FIG. 5, the memory ranking system 504 may include a heatmap classification manager 508. As further shown, the heatmap classification manager 508 may include a hotness evaluator 514, a segment ranker 516, and a segment action manager 518. Each of these components 514-518 may facilitate features and functionality related to determining hotness metrics for memory segments, ranking the memory segments of a memory resource, and performing various actions on the memory segments based on the hotness metrics.

For example, the hotness evaluator 514 may evaluate the access metrics collected and collated by the heatmap access manager 506 to determine one or more metrics of hotness (e.g., hotness metrics) for a collection of memory segments (e.g., memory segments 528 on the memory resource 526). In particular, the hotness evaluator 514 may evaluate access metrics including frequency, recency, density, or other access metrics collected by the heatmap access manager 506 to determine which memory segments of a collection of memory segments are most important or hot relative to other memory segments from the collection.

As will be described in further detail below, the hotness evaluator 514 can evaluate the access metrics to determine a variety of hotness metrics. For instance, in one or more embodiments, the hotness evaluator 514 may calculate an overall hotness score based on one or a combination of multiple access metrics. For example, in one or more embodiments, the hotness evaluator 514 implements a hotness model that employs one or more algorithms or machine learning model(s) trained to determine a metric of importance or hotness based on a combination of one or more factors.

In one or more embodiments, the hotness evaluator 514 employs the hotness model to determine a hotness metric based on a combination of multiple access metrics. For instance, in one or more embodiments, the hotness evaluator 514 can determine a hotness metric based on a combination of a frequency metric, recency metric, density metric, and/or additional access metrics described herein for a corresponding memory segment. For example, a hotness metric may include a score or categorization (e.g., hot, medium, cold) of a memory segment based on some combination of access metrics. In one or more embodiments, the hotness evaluator 514 may consider the types of access instances (e.g., reads, writes) in determining an associated hotness metric. For example, a hotness metric may indicate a ratio of read operations versus write operations to provide a characterization as to how the memory segment is being accessed.

As shown in FIG. 5, the heatmap classification manager 508 may include a segment ranker 516 that determines a relative ranking or characterization of a memory segment relative to one or more additional memory segments. For example, in one or more embodiments, the segment ranker 516 ranks a set of memory segments in order of a hotness score determined based on a combination of access metrics. As an example, in one or more embodiments, the segment ranker 516 simply ranks a set of memory segments (e.g., on a single memory resource or across multiple memory resources) in order of a corresponding hotness score.

In addition to ranking the memory segments relative to one another, the segment ranker 516 may additionally provide a characterization of the memory segments in other ways. For example, in one or more embodiments, the segment ranker 516 provides a characterization of the memory segments based on an evaluation of segment characteristics. For instance, the segment ranker 516 may categorize the memory segments within hotness categories or buckets such as hot, medium, and cold (and/or additional categories) where the respective categories are determined based on threshold hotness metrics determined by the hotness evaluator 514.

In addition to ranking and hotness categorization, in one or more embodiments, the segment ranker 516 characterizes the segments within different groups based on a nature of access instances with respect to the memory segments. For example, the segment ranker 516 may group the memory segments within respective categories based on access types (e.g., read, write). For instance, a first group of memory segments may indicate a high ratio of write operations while a second grouping of memory segments may indicate a high ratio of read operations while a third grouping of memory segments may indicate a more even combination of read and write operations performed with respect to memory segments categorized therein.

It will be appreciated that the segment ranker 516 can categorize or otherwise classify the memory segments based on any of the above factors including some combination of the above factors. For example, the segment ranker 516 may group memory segments within respective groups based on a combination of access metrics as well as an associated nature of access instances with respect to the memory segments. In one or more embodiments, the segment ranker 516 may associate one or more memory segments with different respective groupings, such as associating a first memory segment that is accessed at a high frequency using primarily read operations within both a first grouping of hot segments as well as a second grouping of segments that are primarily accessed using read operations.

As further shown, the heatmap classification manager 508 may include a segment action manager 518. The segment action manager 518 may perform a number of actions on one or more memory segments based on determined hotness metrics and in accordance with a number of policies. For example, the segment action manager 518 may determine to perform one or more acts on any number of memory segments based on determined hotness metrics and/or classifications of the associated memory segments.

In one or more embodiments, the segment action manager 518 may cause one or more memory segments to be migrated from a memory resource to a local memory system 522. By way of example, the segment action manager 518 may determine to migrate a hot memory segment to the local memory system 522 based on the virtual machines 520 being capable of accessing memory resources thereon at lower latencies than when accessing the memory segments 528 on the memory resource 526 managed by the memory controller(s) 524. As noted above, the determination of hotness and whether to migrate the associated memory segment may be based on a combination of multiple access metrics, such as a determination that a memory segment is accessed at a high frequency and at a high density that merits moving the memory segment to the local memory system 522 having higher access speeds than when managed by the memory controller(s) 524.

As an alternative to migrating a memory segment to achieve faster access speeds, in one or more embodiments, the segment action manager 518 may determine to migrate or otherwise move a memory segment to achieve better performance generally. For example, where a hotness metric indicates that access instances for a particular memory segment are primarily write operations, the segment action manager 518 may determine that a different type of device hardware is optimal for the memory segment than the type of device hardware on which the memory segment currently resides. Accordingly, the segment action manager 518 may determine that a memory segment should be moved to a different memory resource on the computing device 502 or on a different memory device based on the hotness metric classifying the memory segment as a write-only segment (or other classification).

In one or more embodiments, the segment action manager 518 performs an analysis of processing and/or time costs associated with migrating a particular segment in view of an estimated benefit of migrating the memory segment. For example, even where a memory segment is being accessed at a high frequency, but not at a high density, the segment action manager 518 may consider a size of the segment or a percentage of the memory segment being accessed with high frequency and a cost associated with migrating the segment to another memory resource. Indeed, where a memory segment is quite large and where only a small portion of the memory segment is being accessed, the segment action manager 518 determine not to cause the memory segment to be migrated to another memory resource based on a processing cost or time required to migrate the memory segment to another memory resource.

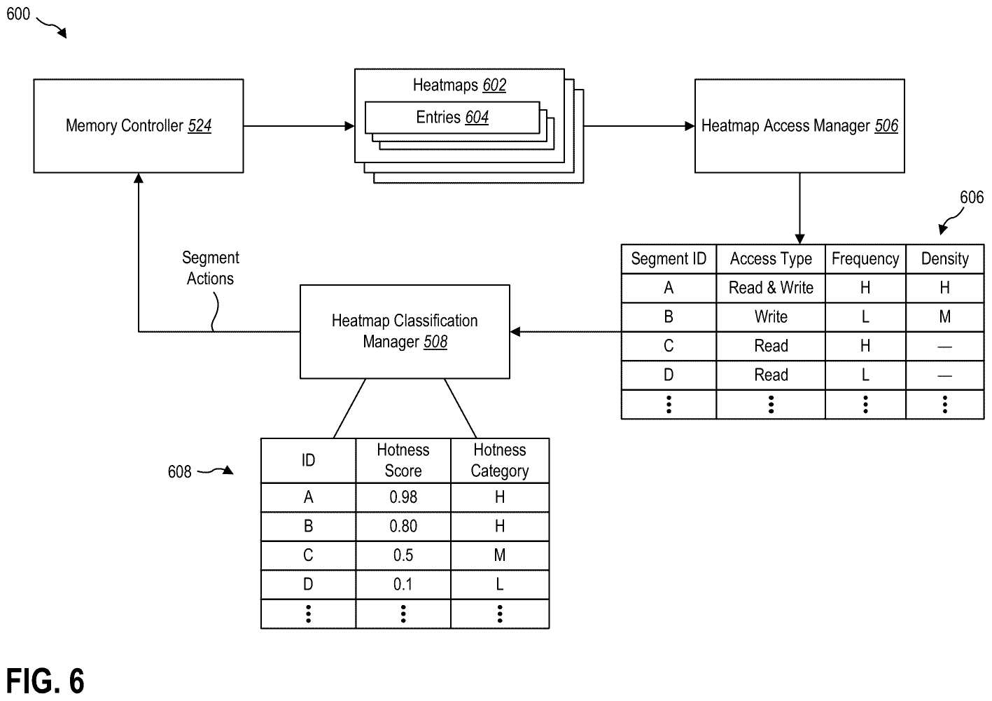

Additional information will now be provided to discuss features and functionality of the memory ranking system in connection with example implementations. For example, FIG. 6 illustrates an example workflow 600 showing features and functionality related to collecting and compiling the memory usage data, evaluating and classifying the memory usage data, and performing one or more actions on memory segments of a memory resource based on how the memory segments are classified (e.g., based on determined hotness metrics).

As shown in FIG. 6, a memory controller 524 may provide heatmaps 602 including segment entries 604 to a heatmap access manager 506. Consistent with one or more embodiments described herein, the memory controller 524 can track memory usage data and generate heatmaps 602 that include segment entries 604 having a variety of access metrics descriptive of access instances for a plurality of memory segments. In one or more embodiments, the memory controller 524 provides the heatmaps 602 and associated memory usage data by exposing the heatmaps 602 for reading by the heatmap access manager 506.

The heatmap access manager 506 may read the heatmaps 602 from the memory controller 524 any number of times and at periodic intervals. Further, in one or more embodiments, the data from the heatmaps 602 resets or otherwise clears to zero on each subsequent read by the heatmap access manager 506. In this way, each of the heatmaps 602 provide memory usage data limited to a duration of time between the last time the heatmaps 602 were read and a current time when the heatmap access manager 506 reads the data from the heatmaps 602.

As shown in FIG. 6, the heatmap access manager 506 can generate compiled memory usage data based on access metrics from the heatmaps 602 over a duration of time. For example, as shown in FIG. 6, the heatmap access manager 506 may generate a heatmap compilation 606 including a listing of each segment and associated memory usage data therein. In particular, as shown in FIG. 6, the heatmap compilation 606 may include a segment identifier for each of multiple segments accessible to the heatmap access manager 506 and memory usage data associated with the respective segment identifiers.

In particular, as shown in FIG. 6, the heatmap compilation 606 may include a table of values representative of memory usage for each of a plurality of memory segments. In this example, the heatmap compilation 606 may include segment identifiers (e.g., segment A, segment B, etc.) and associated access metrics. As shown in FIG. 6, a first segment identifier (segment A) may be associated with a mix of read and write access operations performed at a high frequency and having high density based on access metrics tracked by a corresponding memory controller. Along similar lines, a second segment identifier (segment B) may be associated with primarily write operations at a low frequency and a high density based on access metrics tracked by a corresponding memory controller. Other memory segments may include other metrics associated therewith.

In accordance with one or more embodiments discussed above, in combining the heatmaps 602, the heatmap access manager 506 may generate the heatmap compilation 606 from multiple memory controllers notwithstanding one or more memory controllers having different tracking capabilities. For example, as shown in FIG. 6, a third memory segment (segment C) may be associated with read operations at a high frequency, but not have any information associated with a density metric. This may be a result of the memory controller lacking a capability to track density metrics. Similarly, the fourth memory segment (segment D) may not have an associated memory segment.

Upon compiling the memory usage data, the heatmap compilation 606 may be provided to the heatmap classification manager 508 to perform additional analysis and processing of the memory usage data. For example, as shown in FIG. 6, the heatmap classification manager 508 can generate a hotness record including a set of hotness metrics for each of the memory segments from the heatmaps 602. As shown in FIG. 6., the heatmap classification manager 508 may analyze data from the heatmap compilation 606 to determine a variety of hotness metrics and, in some instances, rank the memory segments in order of a defined or policy-driven notion of hotness.

As mentioned above, in one or more embodiments, the heatmap classification manager 508 employs a hotness analysis model on the memory usage data to determine one or multiple hotness metrics. For example, the heatmap classification manager 508 may apply a machine learning model, algorithm(s), or other model trained to calculate a hotness score or other value(s) based on input data including access metrics and/or any metric or value included within the heatmap compilation 606.

By way of example, the heatmap classification manager 508 can analyze a combination of access metrics (e.g., historical metrics over time), including frequency, recency, and density values (e.g., high, medium, low classifications or more specific metrics). The heatmap classification manager 508 may further consider the nature of access instances, such as whether access instances for a particular memory segment are primarily read operations, write operations, or a combination of both. The heatmap classification manager 508 may further consider other characteristics of the memory segments such as segment size, memory type, or other feature related to how often and/or how a memory segment is being used by one or multiple access agents.

As shown in FIG. 6, the heatmap classification manager 508 can generate a hotness record 608 including hotness metrics associated with respective memory segments. For example, the hotness record 608 may include a ranking of hotness metrics (e.g., based on a listing of the hotness metrics within the hotness record 608 or a flagged ranking within an ordered list of metrics). The hotness record 608 may include a hotness score indicative an overall hotness for the corresponding memory segments. As further shown, the hotness record 608 may include a categorization of hotness (e.g., hot, medium, cold) based on one or a combination of multiple metrics.

In determining the respective hotness metrics within the hotness record 608, the heatmap classification manager 508 may consider any number of factors and may increase or decrease a corresponding hotness metric based on one or more access metrics. For example, where a first memory segment is accessed with high frequency and high density, the heatmap classification manager 508 may determine or calculate a very high overall hotness metric for the memory segment. Conversely, where a second memory segment is accessed at a high frequency, but with low density, the heatmap classification manager 508 may determine a lower overall hotness metric (e.g., a medium hotness metric or other classification indicative of the specific pattern of memory usage). This different classification may hold true even where the frequency metric for the second memory segment indicates memory accesses at a higher frequency for the second memory segment than the first memory segment.

In accordance with one or more embodiments described above, one or more memory segments may not have one or more associated access metrics associated therewith. For example, a third memory segment may not have an associated density metric. Accordingly, the heatmap classification manager 508 may determine a combined hotness metric based on a frequency and/or recency metric, but without considering a density metric. In one or more embodiments, the heatmap classification manager 508 may predict or estimate an access metric based on one or more variables (e.g., an average density metric, a predicted density metric) or simply omit the density metric from a calculation of a hotness score. For example, where the heatmap classification manager 508 may weigh a frequency metric and a density metric equally where both metrics are available, the heatmap classification manager 508 may instead weigh the frequency metric much higher than an estimated or normalized density metric where a specific density metric is unavailable (e.g., as a result of a memory controller lacking a specific tracking capability).

Upon determining hotness metrics and identifying overall hotness scores or metrics associated with respective memory segments, the heatmap classification manager 508 may perform a variety of segment actions on one or memory segments. As an illustrative example, the heatmap classification manager 508 may perform a migration action by causing one or more memory segments to be migrated from a memory resource to a local memory system. Indeed, based on one or more memory segments being categorized as very hot based on a combination of high frequency, high density, and/or one or more additional metrics, the heatmap classification manager 508 may cause those hot segments to be selectively migrated to the local memory system based on memory from the local memory system (e.g., local memory system 522) being highly accessible to applications, virtual machines (e.g., VMs 520), or other accessing agents on a corresponding computing device.

Indeed, based on the local memory system having lower latency than a pooled or remote memory resource managed by one or more memory controllers, the heatmap classification manager 508 may choose to selectively migrate the memory segments to the lower latency memory source. Using similar logic or techniques, the heatmap classification manager 508 may also classify one or more memory segments on the local or other low latency memory resource and evict those memory segments to be placed or otherwise maintained on a remote, pooled, or slightly higher latency memory resource.

While one or more embodiments described herein involve selectively migrating a memory segment from a memory resource to a local memory system, the heatmap classification manager 508 may facilitate other segment actions based on the hotness metrics. As an example, where a memory segment is accessed at high frequency and using a specific type of access operation (e.g., read operation, write operation), the heatmap classification manager 508 may cause the memory segment to be moved between memory hardware of different types. For instance, based on the memory segment being accessed primarily via write operations, the heatmap classification manager 508 may cause the memory segment to be migrated from a memory resource having technology specifications well-suited for providing high-speed read operations to another type of memory hardware having specifications that are better suited for performing write operations thereon.

While one or more embodiments may involve causing a memory segment to migrate to a local memory source (or other memory device) based on a current hotness metric, the heatmap classification manager 508 may additionally evaluate hotness metrics over time and identify patterns or predictions for memory segments based on identified trends. For example, where a memory segment is trending up in access frequency and/or access density, the heatmap classification manager 508 may cause the memory segment to migrate to a local memory or other highly available memory resource based on an estimated memory usage pattern continuing to trend toward a higher overall hotness metric.

Indeed, it will be understood that the heatmap classification manager 508 may perform a variety of segment actions based on hotness metrics. For example, in one or more embodiments, the heatmap classification manager 508 may evaluate the hotness metrics to identify analogous memory usage or access patterns and provide a notification to higher level software. As another example, in one or more embodiments, the heatmap classification manager 508 may upgrade or downgrade a page size due to density of usage information. As a further example, the heatmap classification manager 508 may increase or reduce a size of a remote memory allocation to a host based on a cold memory metric for one or a collection of associated memory segments.

FIG. 7 illustrates another example workflow 700 showing an example implementation in which a memory ranking system (e.g., memory ranking system 504) may be used to sample and combine memory usage data from heatmaps at a determined frequency based on different access resolutions of multiple accessing agents. In particular, FIG. 7 illustrates an example implementation in which the usage data collector 510 and usage data compiler 512 sample and combine memory usage data in such a way that accessing agents being configured to collect memory usage information at different frequencies avoid interfering with one another when attempting to read memory usage data from the same heatmap(s).

For example, as shown in FIG. 7, a plurality of accessing agents (e.g., virtual machines 702) may have associated access resolutions. As noted above, the access resolutions may refer to a rate at which the accessing agents are configured to sample memory usage data from one or more memory controllers. For example, a first virtual machine (or other type of accessing agent) may include a policy or have functionality that causes the first virtual machine to sample heatmaps at a first frequency. In contrast, a second virtual machine (or other type of accessing agent) may include a policy or have functionality that causes the second virtual machine to sample heatmaps at a second frequency.

Where the first and second virtual machines are associated with different heatmaps, the heatmap access manager 506 may collect and combine the information by simply combining data from independently sampled heatmaps within a common table or other data object and without further processing the memory usage data. In contrast, where the first and second virtual machines are associated with overlapping memory segments or the same set of memory segments corresponding to heatmap(s) managed by one or more memory controllers, the heatmap classification manager 508 may implement features and functionality to prevent the first and second virtual machines from interfering with one another in reading the heatmap(s) based on different access granularities.

For example, As shown in FIG. 7, the usage data collector 510 may collect frequency information associated with each of multiple virtual machines 702 (e.g., virtual machines A-C). Other implementations may involve additional or fewer virtual machines. Moreover, other implementations may include other types (or a combination of different types) of accessing agents having associated access resolutions. In the example shown in FIG. 7, the usage data collector 510 identifies or otherwise obtains access resolutions for a first virtual machine, second virtual machine, and third virtual machine. In one or more embodiments, the access resolutions may have different frequencies associated with unique configurations of the virtual machines 702 and/or applications running thereon.

As an illustrative example, a first virtual machine (VM-A) may have an access resolution of one second. A second virtual machine (VM-B) may have an access resolution of two seconds. A third virtual machine (VM-C) may have an access resolution of three seconds. Other implementations may have access resolutions of any number of frequencies including much less granular access resolutions (e.g., one or more minutes) or more granular or specific access resolutions (e.g., microseconds, milliseconds).

As discussed above, the usage data collector 510 may consider the access resolutions of the plurality of virtual machines 702 to determine a sample granularity. As used herein a “sample granularity” may refer to a determined frequency based on a combination of multiple access resolutions associated with different accessing agents. For example, in one or more embodiments, the usage data collector 510 may determine a common factor of each of the access resolutions. For example, where the access resolutions are one, two, and three seconds, the usage data collector 510 may identify a common factor (e.g., greatest common factor) of one second based on a determination that one second is a factor of each of one second, two seconds, and three seconds. In this example, therefore, the usage data collector 510 may determine that a sample granularity for the plurality of virtual machines 702 should be one second.

As shown in FIG. 7, the usage data collector 510 can read heatmaps 704 maintained by the memory controller 524 in accordance with the determined sample granularity. For example, the usage data collector 510 can generate or obtain heatmap samples 706 (e.g., samples of memory usage data) at one second intervals based on the sample granularity of one second being a common factor of each of the access resolutions for the virtual machines 702. As shown in FIG. 7, the usage data collector 510 can provide the sampled heatmaps 706 to the usage data compiler 512 for additional processing.

The usage data compiler 512 may compile the heatmap samples 706 in a variety of ways. In one or more embodiments, the usage data compiler 512 generates a heatmap record 708 (e.g., a memory record) including a compilation of the heatmap samples 706. As shown in FIG. 7, this may include sampled segment entries for each of a plurality of heatmap segments obtained at time intervals indicated by the sample granularity (e.g., every one second). For example, the heatmap record 708 may include a first plurality of segment entries for a first memory segment from each of the heatmap samples 706. Similarly, the heatmap record 708 may include a second plurality of segment entries for a second memory segment from each of the heatmap samples 706. Indeed, the heatmap record 708 may include sampled segment entries from each of the heatmap samples 706.

The usage data compiler 512 may utilize the heatmap record 708 to generate a plurality of agent-specific heatmap records 710a-c (e.g., agent-specific records of memory usage data). In particular, the usage data compiler 512 may generate multiple heatmap records 710a-c in which data from the heatmap record 708 is combined based on access resolutions for the corresponding accessing agents.

For example, the usage data compiler 512 may generate a first agent-specific heatmap record 710a in which the heatmap samples 706 and/or sampled entries from the heatmap record 708 are combined in accordance with a first access resolution. In this example, where the first access resolution is the same as the sample granularity used in collecting the heatmap samples 706, the resulting agent-specific heatmap record 710a may be similar or even identical to the heatmap record 708. In contrast, the usage data compiler 512 may generate a second agent-specific heatmap record 710b and a third agent-specific heatmap record 710c in which the heatmap samples 706 and/or sampled entries from the heatmap record 708 are combined in accordance with respective first and second access resolutions. Additional information in connection with an example implementation is discussed below in connection with FIGS. 8A-8B.

The agent-specific heatmap records may include a compilation of the heatmap samples 706 to simulate collection of the data at the corresponding access resolution with or without additional processing performed thereon. For example, in one or more embodiments, the usage data compiler 512 simply combines sets of sampled data by adding a number of sampled entries/heatmaps to simulate how the data would have appeared if sampled at the corresponding access resolution(s). In addition, or as an alternative, the usage data compiler 512 may combine the sampled data according to the access resolutions and perform further processing to determine trends of memory usage over time (e.g., similar to the example discussed above in the heatmap compilation of FIG. 6).

As shown in FIG. 7, upon generating the agent-specific heatmap records 710a-c, the usage data compiler 512 may share memory usage data with the plurality of virtual machines. In particular, the usage data compiler 512 can share data from each of the agent-specific heatmap records 710a-c with a corresponding accessing agent (e.g., based on the access resolution for the corresponding agent).

While FIG. 7 illustrates an example where each virtual machine has a corresponding agent-specific heatmap record, in one or more embodiments, the usage data compiler 512 may simply generate any number of heatmap records corresponding to a number of different access resolutions. In this way, where two accessing agents having access to the same set of memory segments may have the same access resolution, the usage data compiler 512 may generate a single agent-specific heatmap record and share memory usage data from the heatmap record with both of the accessing agents based on the accessing agents having the same access resolution associated with the heatmap record.

As noted above, the usage data compiler 512 can combine the sampled memory usage data in a variety of ways. In one or more embodiments, the usage data compiler 512 can combine the sampled memory usage data with the agent-specific heatmap records in a way that simulates what the memory usage data would have looked like had the heatmaps been sampled at the same frequency as the corresponding access resolution. Indeed, in this way, the usage data compiler 512 emulates the memory usage data from the sampled heatmaps to look like memory usage data sampled by the respective accessing agents.

For example, FIGS. 8A-8B illustrate example implementations showing an example in which the usage data compiler 512 emulates the tracking data as if the heatmaps were read by the specific accessing agents. In particular, FIGS. 8A-8B show two example agent-specific heatmap records generated based on memory usage data sampled at a one second sample granularity to simulate access resolutions of accessing agents associated with access.

In particular, FIG. 8A illustrates a first implementation in which a usage data compiler 512 generates a heatmap record 802 including any number of heatmap samples 806a-n read at a one-second frequency from a memory controller. Where data from the heatmap(s) is cleared on each reach, each heatmap sample is representative of access instances for a one-second period from a previous heatmap read. Accordingly, the heatmap(s) are cleared every one second in accordance with the sample granularity at which the heatmap samples 806a-n are collected.

In this example, a first agent-specific heatmap record 804a has a two-second access resolution based on an access resolution for an associated virtual machine, application, or other accessing agent. In accordance with one or more embodiments described above, the usage data compiler 512 can combine heatmap samples based on the access resolution and the sample granularity. In particular, as shown in FIG. 8A, the usage data compiler 512 can generate combined heatmap samples 808a-n by grouping sets of two heatmap samples together. The usage data compiler 512 may group the heatmap samples to simulate collection of memory usage data as if the heatmaps from the memory controllers were read from a corresponding accessing agent. For instance, in this example, the combined heatmap samples 808a-c may include memory usage data that simulates the heatmap sampling as if the heatmaps were sampled at two second increments.

More specifically, in this implementation, data from the first and second heatmap samples 806a-b may be combined to generate the first combined heatmap samples 808a. This may be performed by summing together or otherwise combining access metrics from the respective segment entries and/or heatmaps. For instance, where the heatmap samples 808a-b include frequency metrics indicating a count of total accesses over the relevant time periods, the usage data compiler 512 may simply sum the first and second frequency metrics within the combined heatmap samples 808a.

As another example, where the heatmap samples 808a-b include recency metrics or density metrics, the usage data compiler 512 can combine these metrics to simulate what the values would have read had the heatmap been read on two second intervals instead of one. For example, where the recency value from the second heatmap sample 806b is non-zero, the usage data compiler 512 may simply discard the recency value from the first heatmap sample 806a and include the recency value from the second heatmap sample 806b within the combined heatmap sample 808a. Indeed, the usage data compiler 512 may simply use any whichever non-zero recency metric was obtained most recently between the heatmap samples. Additionally, in combining the density values from the heatmap samples, the usage data compiler 512 may carry through all non-zero values to indicate whether a portion of a memory segment was accessed during either second of the two-second interval represented by the respective heatmap samples 806a-b.

The usage data compiler 512 may similarly combine pairs of heatmap samples to generate additional combined heatmap samples. For example, the usage data compiler 512 can combine the third and fourth heatmap samples 806c-d to generate a second combined heatmap sample 808b. Similarly, the usage data compiler 512 can combine the fifth and sixth heatmap samples 806e-f to generate a third combined heatmap sample 808c. The usage data compiler 512 may combine any number of heatmap samples (e.g., over some predetermined period of time) to generate any number of combined heatmap samples. The memory usage data from the first agent-specific heatmap record 804a may be shared with a corresponding accessing agent associated with the same access resolution.

FIG. 8B illustrates a similar implementation showing a second agent-specific heatmap record 804c having a three second resolution based on an access resolution for an associated virtual machine, application, or other accessing agent. In this example, the usage data compiler 512 can group sets of three heatmap samples together using a similar process described above in connection with FIG. 8A. For example, the usage data compiler 512 may combine values from first, second, and third heatmap samples 806a-c to generate a first combined heatmap sample 810a. Similarly, the usage data compiler 512 may combine values from fourth, fifth, and sixth heatmap samples 806d-f to generate a second combined heatmap sample 810b. The memory usage data from the second agent-specific heatmap record 804b may be shared with a corresponding accessing agent associated with the same access resolution.

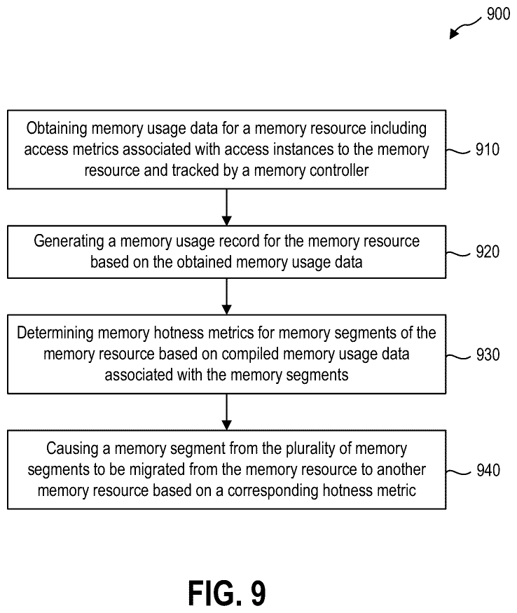

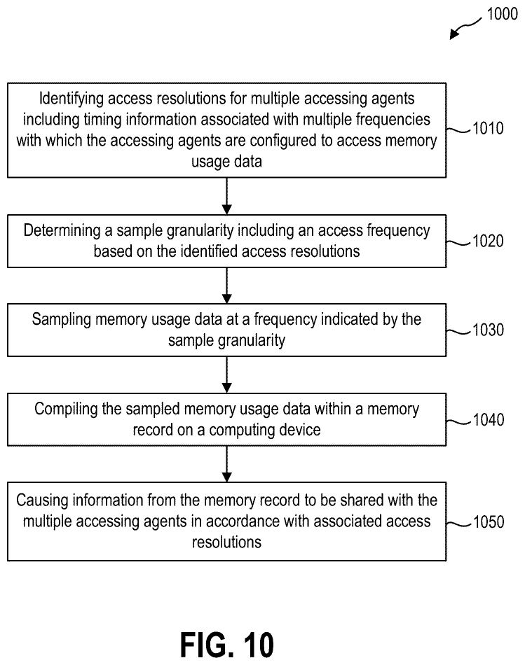

Turning now to FIGS. 9-10, these figures illustrate example flowcharts including series of acts for managing and ranking memory resources in accordance with one or more embodiments. While FIGS. 9-10 illustrate acts according to one or more embodiments, alternative embodiments may omit, add to, reorder, and/or modify any of the acts shown in FIGS. 9-10. The acts of FIG. 9-10 can be performed as part of a method. Alternatively, a non-transitory computer-readable medium can include instructions that, when executed by one or more processors, cause a computing device to perform the acts of FIGS. 9-10. In still further embodiments, a system can perform the acts of FIGS. 9-10.

FIG. 9 illustrates a series of acts 900 related to determining memory hotness for memory segments of a memory resource and implementing a migration of one or more memory segments based on the determined memory hotness. In particular, as shown in FIG. 9, the series of acts 900 includes an act 910 of obtaining memory usage data for a memory resource including access metrics associated with access instances to the memory resource and tracked by a memory controller. For example, in one or more embodiments, the act 910 involves obtaining memory usage data for a first memory resource from one or more memory controllers, the memory usage data including access metrics associated with access instances to the first memory resource. The access metrics may be tracked by the one or more memory controllers with respect to a plurality of memory segments on the first memory resource accessible to a computing device.

In one or more embodiments, obtaining the memory usage data includes reading a heatmap associated with the computing device and maintained by the one or more memory controllers. The heatmap may include a plurality of segment entries for the plurality of memory segments where each of the plurality of segment entries includes one or more access metrics associated with accessing a corresponding memory segment from the plurality of memory segments by the computing device. In one or more embodiments, reading the heatmap causes data from the heatmap to be cleared when read by the computing device. Further, obtaining the memory usage data may include reading the heatmap periodically (e.g., over a predetermined period of time). In one or more embodiments, reading the heatmap includes accessing the heatmap on a different access path than an access path used to interact with the first memory resource.

In one or more embodiments, the one or more memory controllers includes a first memory controller that manages access to a first memory device and a second memory controller that manages access to a second memory device. Further, obtaining the memory usage data may include reading a first heatmap managed by the first memory controller and reading a second heatmap managed by a second memory controller.

In one or more embodiments, the computing device includes a first accessing agent and a second accessing agent having access to the first memory resource. Further, in one or more embodiments, obtaining the memory usage data includes reading a first heatmap including segment entries for a first set of memory segments from the first memory resource including access metrics associated with accessing the first set of memory segments by the first accessing agent. Obtaining the memory usage data may further include reading a second heatmap including segment entries for a second set of memory segments from the first memory resource including access metrics associated with accessing the second set of memory segments by the second accessing agent.

As further shown, the series of acts 900 includes an act 920 of generating a memory usage record for the memory resource based on the obtained memory usage data. For example, in one or more embodiments, the act 920 involves generating a memory usage record for the first memory resource based on the obtained memory usage data, the memory usage record including compiled memory usage data based on obtained access metrics.

As further shown, the series of acts 900 includes an act 930 of determining memory hotness metrics for memory segments of the memory resource based on compiled memory usage data associated with the memory segments. For example, in one or more embodiments, the act 930 involves determining a plurality of memory hotness metrics for the plurality of memory segments, the plurality of memory hotness metrics being based on compiled memory usage data associated with the plurality of memory segments.

As further shown, the series of acts 900 includes an act 940 of causing a memory segment from the plurality of memory segments to be migrated from the memory resource to another memory resource based on a corresponding hotness metric. For example, in one or more embodiments, the act 940 involves causing a memory segment from the plurality of memory segments to be migrated from the first memory resource to a second memory resource based on a memory hotness metric associated with the memory segment.

In one or more embodiments, the access metrics include one or more of a variety of different metrics. For example, the access metrics may include a frequency metric for an associated memory segment where the frequency metric indicates a count of access instances for the associated memory segment since a last time that the memory usage data was obtained by the computing device. The access metrics may also include a recency metric for the associated memory segment where the recency metric indicates a recency of when a segment entry for the associated memory segment was last accessed. The access metric may also include a density metric for the associated memory segment where the density metric includes a plurality of values associated with multiple portions of the memory segment and indicating respective portions of the memory segment that have been accessed since the last time that the memory usage data was obtained by the computing device.

In one or more embodiments, the one or more memory controllers includes a first memory controller associated with a first memory device and a second memory controller associated with a second memory device. The first memory controller may be configured to track a first set of one or more access metrics with respect to memory segments on the first memory device. The second memory controller may be configured to track a second set of one or more access metrics with respect to memory segments on the second memory device. The second set of one or more access metrics may be different from the first set of one or more access metrics.

In one or more embodiments, the plurality of memory hotness metrics includes, for each memory segment of the plurality of memory segments, a hotness score based on a combination of a frequency metric and a density metric for the associated memory segment. In one or more embodiments, causing the memory segment to be migrated from the memory resource to another memory resource includes causing the memory segment to be migrated from a first memory resource to a second memory resource having a lower access latency than the first memory resource.

In one or more embodiments, the memory usage data further includes information associated with read instances and write instances. In one or more embodiments, the plurality of memory hotness metrics includes a ratio of read instances to write instances. In one or more embodiments, causing the memory segment to be migrated to another memory resource includes causing the memory segment to be migrated to the another memory resource (e.g., of the same or different memory type than the memory resource) based on the ratio of read instances to write instances.

FIG. 10 illustrates a series of acts related to collecting and sharing memory usage data in accordance with one or more embodiments described herein. For example, as shown in FIG. 10, the series of acts 1000 may include an act 1010 of identifying access resolutions for multiple accessing agents including timing information associated with multiple frequencies with which the accessing agents are configured to access memory usage data. For example, in one or more embodiments, the act 1010 involves identifying access resolutions for a plurality of accessing agents on a computing device, the access resolutions including timing information associated with frequencies with which accessing agents are configured to access memory usage data for a memory resource.

As further shown, the series of acts 1000 includes an act 1020 of determining a sample granularity including an access frequency based on the identified access resolutions. For example, in one or more embodiments, the act 1020 involves determining a sample granularity including an access frequency based on a common factor of the access resolutions for the plurality of accessing agents.

As further shown, the series of acts 1000 includes an act 1030 of sampling memory usage data at a frequency indicated by the sample granularity. For example, in one or more embodiments, the act 1030 involves obtaining samples of memory usage data at the access frequency indicated by the sample granularity where the samples of memory usage data for the memory resource include access metrics associated with access instances to the memory resource by the computing device. In one or more embodiments, the access metrics are tracked by one or more memory controllers that manage access to the memory resource.

As further shown, the series of acts 1000 includes an act 1040 of compiling the samples of memory usage data within a memory record on the computing device. As further shown, the series of acts 1000 includes an act 1050 of causing information from the memory record to be shared with the multiple accessing agents in accordance with associated access resolutions. For example, in one or more embodiments, the act 1050 involves causing information from the memory record to be shared with the plurality of accessing agents in accordance with the identified access resolutions.

In one or more embodiments, the access resolutions include a first access resolution associated with a first frequency with which a first accessing agent is configured to access the memory usage data and a second access resolution associated with a second frequency with which a second accessing agent is configured to access the memory usage data. In one or more embodiments, determining the sample granularity includes determining the common factor for the first accessing agent and the second accessing agent and calculating a sampling frequency that is a factor of both the first frequency associated with the first accessing agent and the second frequency associated with the second accessing agent.

In one or more embodiments, the series of acts 1000 includes generating a plurality of agent-specific memory usage records for the plurality of accessing agents based on associated access resolutions for the plurality of accessing agents. In one or more embodiments, generating the plurality of agent-specific memory usage records includes, for each accessing agent of the plurality of accessing agents, combining sets of samples of memory usage data from the obtained samples of memory usage data, the sets of samples including a number of samples based on a ratio between the sample granularity and an access resolution for the accessing agent. In one or more embodiments, generating the plurality of agent-specific memory usage records includes combining sets of samples of memory usage data to simulate a collection of memory usage data at the associated access resolutions as if the memory usage data was sampled at the frequencies of the associated access resolutions. In one or more embodiments, causing information from the memory record to be shared with the plurality of accessing agents includes providing, for each accessing agent of the plurality of accessing agents, information from a respective agent-specific memory usage record from the plurality of agent-specific memory usage records.

In one or more embodiments, obtaining samples of memory usage data includes obtaining the samples of memory usage data across multiple memory devices having the one or more memory controllers implemented thereon. In addition, compiling sample of memory usage may include compiling samples of memory usage data from each of the multiple memory devices within a common memory usage record stored on the computing device.

In one or more embodiments, obtaining the samples of memory usage data comprises reading one or more heatmaps on the one or more memory controllers at a frequency in accordance with the determined sample granularity. Reading the one or more heatmaps on the one or more memory controllers may further cause data from the one or more heatmaps to be cleared when read by the computing device.

FIG. 11 illustrates certain components that may be included within a computer system 1100. One or more computer systems 1100 may be used to implement the various devices, components, and systems described herein.

The computer system 1100 includes a processor 1101. The processor 1101 may be a general-purpose single- or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 1101 may be referred to as a central processing unit (CPU). Although just a single processor 1101 is shown in the computer system 1100 of FIG. 11, in an alternative configuration, a combination of processors (e.g., an ARM and DSP) could be used.

The computer system 1100 also includes memory 1103 in electronic communication with the processor 1101. The memory 1103 may be any electronic component capable of storing electronic information. For example, the memory 1103 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 1105 and data 1107 may be stored in the memory 1103. The instructions 1105 may be executable by the processor 1101 to implement some or all of the functionality disclosed herein. Executing the instructions 1105 may involve the use of the data 1107 that is stored in the memory 1103. Any of the various examples of modules and components described herein may be implemented, partially or wholly, as instructions 1105 stored in memory 1103 and executed by the processor 1101. Any of the various examples of data described herein may be among the data 1107 that is stored in memory 1103 and used during execution of the instructions 1105 by the processor 1101.

A computer system 1100 may also include one or more communication interfaces 1109 for communicating with other electronic devices. The communication interface(s) 1109 may be based on wired communication technology, wireless communication technology, or both. Some examples of communication interfaces 1109 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 1100 may also include one or more input devices 1111 and one or more output devices 1113. Some examples of input devices 1111 include a keyboard, mouse, microphone, remote control device, button, joystick, trackball, touchpad, and lightpen. Some examples of output devices 1113 include a speaker and a printer. One specific type of output device that is typically included in a computer system 1100 is a display device 1115. Display devices 1115 used with embodiments disclosed herein may utilize any suitable image projection technology, such as liquid crystal display (LCD), light-emitting diode (LED), gas plasma, electroluminescence, or the like. A display controller 1117 may also be provided, for converting data 1107 stored in the memory 1103 into text, graphics, and/or moving images (as appropriate) shown on the display device 1115.

The various components of the computer system 1100 may be coupled together by one or more buses, which may include a power bus, a control signal bus, a status signal bus, a data bus, etc. For the sake of clarity, the various buses are illustrated in FIG. 11 as a bus system 1119.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various embodiments.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

As used herein, non-transitory computer-readable storage media (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
identifying access resolutions for a plurality of accessing agents on a computing device, the access resolutions including timing information associated with frequencies with which accessing agents are configured to access memory usage data for a memory resource;
determining a sample granularity including an access frequency based on a common factor of the access resolutions for the plurality of accessing agents;
obtaining samples of memory usage data at the access frequency indicated by the sample granularity, wherein the samples of memory usage data for the memory resource include access metrics associated with access instances to the memory resource by the computing device, and wherein the access metrics are tracked by one or more memory controllers that manage access to the memory resource;
compiling the samples of memory usage data within a memory record on the computing device; and
causing information from the memory record to be shared with the plurality of accessing agents in accordance with the identified access resolutions.

2. The method of claim 1, wherein the access resolutions include a first access resolution associated with a first frequency with which a first accessing agent is configured to access the memory usage data and a second access resolution associated with a second frequency with which a second accessing agent is configured to access the memory usage data, wherein determining the sample granularity includes determining the common factor for the first accessing agent and the second accessing agent and calculating a sampling frequency that is a factor of both the first frequency associated with the first accessing agent and the second frequency associated with the second accessing agent.

3. The method of claim 1, further comprising generating a plurality of agent-specific memory usage records for the plurality of accessing agents based on associated access resolutions for the plurality of accessing agents.

4. The method of claim 3, wherein generating the plurality of agent-specific memory usage records comprises, for each accessing agent of the plurality of accessing agents, combining sets of samples of memory usage data from the obtained samples of memory usage data, the sets of samples including a number of samples based on a ratio between the sample granularity and an access resolution for the accessing agent.

5. The method of claim 3, wherein generating the plurality of agent-specific memory usage records includes combining sets of samples of memory usage data to simulate a collection of memory usage data at the associated access resolutions as if the memory usage data was sampled at the frequencies of the associated access resolutions.

6. The method of claim 3, wherein causing information from the memory record to be shared with the plurality of accessing agents comprises providing, for each accessing agent of the plurality of accessing agents, information from a respective agent-specific memory usage record from the plurality of agent-specific memory usage records.

7. The method of claim 1,
wherein the samples of memory usage data are obtained from multiple memory devices having the one or more memory controllers implemented thereon, and
wherein the samples of memory usage data are compiled from each of the multiple memory devices within a common memory usage record stored on the computing device.

8. The method of claim 1, wherein obtaining the samples of memory usage data comprises reading one or more heatmaps on the one or more memory controllers at a frequency in accordance with the determined sample granularity, and wherein reading the one or more heatmaps on the one or more memory controllers causes data from the one or more heatmaps to be cleared when read by the computing device.

9. The method of claim 8, wherein the one or more heatmaps are locally maintained on the one or more memory controllers.

10. The method of claim 1, wherein the memory resource is a volatile memory resource.

11. A system, comprising:
at least one processor;
memory in electronic communication with the at least one processor;
instructions stored in the memory, the instructions being executable by the at least one processor to:
identify access resolutions for a plurality of accessing agents on a computing device, the access resolutions including timing information associated with frequencies with which accessing agents are configured to access memory usage data for a memory resource;
determine a sample granularity including an access frequency based on a common factor of the access resolutions for the plurality of accessing agents;
obtain samples of memory usage data at the access frequency indicated by the sample granularity, wherein the samples of memory usage data for the memory resource include access metrics associated with access instances to the memory resource by the computing device, and wherein the access metrics are tracked by one or more memory controllers that manage access to the memory resource;
compile the samples of memory usage data within a memory record on the computing device; and
cause information from the memory record to be shared with the plurality of accessing agents in accordance with the identified access resolutions.

12. The system of claim 11, wherein the access resolutions include a first access resolution associated with a first frequency with which a first accessing agent is configured to access the memory usage data and a second access resolution associated with a second frequency with which a second accessing agent is configured to access the memory usage data, wherein determining the sample granularity includes determining the common factor for the first accessing agent and the second accessing agent and calculating a sampling frequency that is a factor of both the first frequency associated with the first accessing agent and the second frequency associated with the second accessing agent.

13. The system of claim 11, further comprising instructions being executable by the at least one processor to generate a plurality of agent-specific memory usage records for the plurality of accessing agents based on associated access resolutions for the plurality of accessing agents.

14. The system of claim 13, wherein generating the plurality of agent-specific memory usage records comprises, for each accessing agent of the plurality of accessing agents, combining sets of samples of memory usage data from the obtained samples of memory usage data, the sets of samples including a number of samples based on a ratio between the sample granularity and an access resolution for the accessing agent.

15. The system of claim 13, wherein generating the plurality of agent-specific memory usage records includes combining sets of samples of memory usage data to simulate a collection of memory usage data at the associated access resolutions as if the memory usage data was sampled at the frequencies of the associated access resolutions.

16. The system of claim 13, wherein causing information from the memory record to be shared with the plurality of accessing agents comprises providing, for each accessing agent of the plurality of accessing agents, information from a respective agent-specific memory usage record from the plurality of agent-specific memory usage records.

17. The system of claim 13,
wherein the samples of memory usage data are obtained from multiple memory devices having the one or more memory controllers implemented thereon, and
wherein the samples of memory usage data are compiled from each of the multiple memory devices within a common memory usage record stored on the computing device.

18. The system of claim 11, wherein obtaining the samples of memory usage data comprises reading one or more heatmaps locally maintained on the one or more memory controllers at a frequency in accordance with the determined sample granularity, and wherein reading the one or more heatmaps on the one or more memory controllers causes data from the one or more heatmaps to be cleared when read by the computing device.

19. A non-transitory computer readable storage medium storing instructions thereon that, when executed by at least one processor, causes a computing device to:
identify access resolutions for a plurality of accessing agents on the computing device, the access resolutions including timing information associated with frequencies with which accessing agents are configured to access memory usage data for a memory resource;
determine a sample granularity including an access frequency based on a common factor of the access resolutions for the plurality of accessing agents;
obtain samples of memory usage data at the access frequency indicated by the sample granularity, wherein the samples of memory usage data for the memory resource include access metrics associated with access instances to the memory resource by the computing device, and wherein the access metrics are tracked by one or more memory controllers that manage access to the memory resource;
compile the samples of memory usage data within a memory record on the computing device; and
cause information from the memory record to be shared with the plurality of accessing agents in accordance with the identified access resolutions.

20. The non-transitory computer readable medium of claim 19, wherein the access resolutions include a first access resolution associated with a first frequency with which a first accessing agent is configured to access the memory usage data and a second access resolution associated with a second frequency with which a second accessing agent is configured to access the memory usage data, wherein determining the sample granularity includes determining the common factor for the first accessing agent and the second accessing agent and calculating a sampling frequency that is a factor of both the first frequency associated with the first accessing agent and the second frequency associated with the second accessing agent.
